(19) United States
(12) Patent Application Publication
(10) Pub. No.: US 2011/0050686 A1
(43) Pub. Date: Mar. 3, 2011

(54) THREE-DIMENSIONAL DATA DISPLAY APPARATUS AND METHOD

(75) Inventors: Kai NOJIMA, Kawasaki (JP); Atsushi Takeuchi, Kawasaki (JP); Kenji Nagase, Kawasaki (JP); Eiji Ohta, Kawasaki (JP)

(73) Assignee: FUJITSU LIMITED, Kawasaki-shi (JP)

(21) Appl. No.: 12/862,981

(22) Filed: Aug. 25, 2010

(30) Foreign Application Priority Data
Aug. 26, 2009 (JP) 2009-194986

(51) Int. Cl. G06T 15/00

(52) U.S. Cl. 345/419

(57) ABSTRACT

A three-dimensional data display apparatus is provided with a screen display processing section that generates a display screen with a structure arranged in a virtual space of a three-dimensional orthogonal coordinate system based on structure information stored in a data storage section and displays the display screen on a monitor, a grid setting-updating section that sets a grid in the virtual space, an operation information acquiring section that acquires operation information from a mouse, an input point position calculation section that calculates coordinates of an input point in the virtual space, calculates a moving destination of the input point based on the operation information, selects coordinates nearest to the moving destination of the input point from any one of the coordinates of each grid lattice based on the grid in the virtual space, the coordinates of a boundary of the structure and the coordinates of the point of intersection between the boundary of the structure and the grid and updates the coordinates of the input point and an input point display processing section that displays the input point at the updated coordinates.

### CROSS-REFERENCE TO RELATED APPLICATION

This application is based upon and claims the benefit of priority of the prior Japanese Patent Application No. 2009-194986 filed on Aug. 26, 2009, the entire contents of which are incorporated herein by reference.

### FIELD

The embodiments discussed herein are related to a three-dimensional data display apparatus and program for displaying a model generated using three-dimensional structure data of a structure to be processed in a virtual space of three-dimensional orthogonal coordinates configured through calculation processing.

### BACKGROUND

With drastic improvements in computer throughput, scale and parallelization techniques in recent years, signal analysis processing is being actively performed in applications of not only circuit simulation processing but also three-dimensional electromagnetic field simulation processing.

A three-dimensional electromagnetic field simulator using an electromagnetic field analysis processing method using a three-dimensional grid structure, for example, FDTD (Finite Difference Time Domain Method) requires an operation of setting a voltage source and a resistive element between a signal line and a grounding line when performing a circuit analysis or the like including a three-dimensional space.

Therefore, a data input device or the like is proposed. The data input device has external coordinate value input means that can enter coordinate values of two-dimensional coordinates on an external plane and built-in coordinate value input means that can enter coordinate values of coordinates carried on a movable member through relative movement with respect to a movable member built in the apparatus body.

In addition, a three-dimensional pointing method or the like is proposed for pointing an object disposed at a depth position in a three-dimensional GUI in one region at the depth position and at the same time changing the position in the two-dimensional plane according to the pointed depth position.

Furthermore, a mouse type input device that can enter three-dimensional coordinates is proposed. The mouse type input device has a dial function and an input section that allows analog displacement to be inputted to a computer or the like by operating the dial function.

Furthermore, a three-dimensional cursor control device is proposed. The three-dimensional cursor control device has means that can set a three-dimensional section formed perpendicular to a depth direction and in the vicinity of a cursor as the cursor position moves in the depth direction and can highlight three-dimensional graphics in the three-dimensional section.

The following are documents describe technical backgrounds of the discussed embodiments:

### Japanese Patent Laid-Open No. 6-250781 (Patent Document 1),

### Japanese Patent Laid-Open No. 2007-140186 (Patent Document 2),

### Japanese Patent Laid-Open No. 5-108263 (Patent Document 3), and

### Japanese Patent No. 2892360 (Patent Document 4).

Most of structure data of a three-dimensional structure, which is used for a three-dimensional electromagnetic field simulator, is generally created through automatic data conversion processing or the like from data created by a CAD (Computer Aided Design) system using a computer.

However, there still remains steps that the user must manually set via a three-dimensional space displayed on a screen such as a setting of an output region and an addition of three-dimensional structure data. With a three-dimensional electromagnetic field simulator, for example, when arranging a wave source and circuit elements or the like between structure bodies (metal bodies), the user must perform an input operation of arranging the elements or the like while visually checking the boundary of a desired metal body in the three-dimensional space two-dimensionally expressed on the display screen so as to contact the metal body, that is, arranging end points of the elements or the like on the boundary of the metal body. When circuit elements or the like are arranged with end points thereof not contacting the structure body (metal body), the arranged end points are handled as “being left open” in calculations, producing erroneous results in circuit characteristics, and therefore precise arrangement of the end points is required.

However, since three-dimensional parts and structures are expressed on a two-dimensional plane by the three-dimensional data display apparatus, the depth direction of the three-dimensional space cannot help but be expressed in a pseudo-form using an optical illusion of the user. Therefore, it is difficult for the user to visually grasp the exact position in the three-dimensional space on the screen and exactly identify a desired position.

With the three-dimensional electromagnetic field simulator, the operation of accurately arranging the wave source and circuit elements is particularly not easy and there is a problem that the accuracy and efficiency of the user's operation deteriorate. Moreover, there is also a problem that the deterioration of the accuracy of the operation produces wasteful analysis processing based on misalignment or the like.

### SUMMARY

The three-dimensional data display apparatus disclosed as one embodiment of the present invention is a three-dimensional data display apparatus provided with a display device and a pointing input device for causing the display device to display a structure to be processed in a virtual space. The three-dimensional data display apparatus includes a structure information storage section that stores structure information including structure information indicating a shape and arrangement of the structure and physical property value information indicating a material and a predetermined physical property value, a screen display processing section that generates a display screen with a structure arranged in a virtual space of a three-dimensional orthogonal coordinate system based on the structure information and displays the generated display screen on the display device, a grid setting section that sets a grid in the virtual space based on predetermined grid spacing, an operation information acquiring section that acquires operation information indicating a moving direction and an amount of movement of the input point from the pointing input device, an input point position calculation section that calculates coordinates in the virtual space of the input point, calculates a moving destination of the input point based on the operation information, selects any one of coordinates of each grid lattice based on the set grid, coordinates of a boundary of the structure and coordinates of an intersection between the boundary of the structure and the grid as coordinates at a minimum distance from the moving destination and updates the coordinates of the input point with the selected coordinates, and an input point display processing section that displays, when the coordinates of the input point are updated, the input point at a position indicating the updated coordinates of the input point in the virtual space.

The three-dimensional data display apparatus disclosed as one embodiment of the present invention can provide a graphic user interface that can highlight, when the user checks or creates structure data of a structure to be processed, the boundary of the structure arranged in the virtual three-dimensional space in which a grid is set and further can display a setting position of a terminal or the like on the grid or the boundary of the structure.

According to the disclosed three-dimensional data display apparatus, it allows the user to easily and reliably recognize the boundary of the structure to be processed on a display screen and easily and reliably perform operation of inputting a setting of a terminal or the like. This also allows the user to avoid operation errors such as a setting position error. Thus, it is possible to realize a drastic reduction of operation time of creating structure data and a reduction of processing cost resulting from wasteful calculation processing or the like based on erroneous input of the setting position.

The object and advantage of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating a configuration of a three-dimensional data display system disclosed as one embodiment;

FIG. 2 is a diagram illustrating a grid and a grid lattice according to the embodiment;

FIG. 3 is a diagram illustrating an example of structure information (structure data);

FIGS. 4 and 5 are diagrams illustrating an overview of a processing flow of the three-dimensional data display apparatus according to the embodiment;

FIG. 6 is a diagram illustrating a more specific example of structure data;

FIG. 7 is a diagram illustrating a grid lattice setting according to the embodiment;

FIG. 8 is a diagram illustrating an auxiliary grid lattice based on a structure arranged on the grid lattice according to the embodiment;

FIG. 9 is a diagram illustrating an example of a grid table;

FIGS. 10A and 10B are diagrams illustrating sketch plane settings according to the embodiment;

FIGS. 11A, 11B and 11C are diagrams illustrating switching between display modes of a display screen according to the embodiment;

FIG. 12 is a diagram illustrating movement of an input point according to the embodiment;

FIGS. 13A and 13B are diagrams illustrating movements of an input point using a mouse that allows two ways of moving operation according to the embodiment;

FIGS. 14A to 14E are diagrams illustrating examples of highlighting of a structure according to the embodiment;

FIGS. 15A and 15B are diagrams illustrating examples of display of physical property value information on a structure according to the embodiment;

FIG. 16 is a diagram illustrating display processing of a structure in the vicinity of an input point according to the embodiment;

FIGS. 17A, 17B and 17C are diagrams illustrating examples of display of a line of intersection between a sketch plane and a boundary plane by a first guide display;

FIG. 18 is a diagram illustrating an example of display of a guide line from an input point by a second guide display;

FIG. 19 is a diagram illustrating display processing of a rotation coordinate system according to the embodiment;

FIG. 20 is a diagram illustrating creation of a rectangular parallelepiped structure according to the embodiment;

FIG. 21 is a diagram illustrating a processing flow of grid setting processing according to a grid table;

FIG. 22 is a diagram illustrating a processing flow of sketch plane setting processing;

FIG. 23 is a diagram illustrating a processing flow of input point moving processing according to the grid table;

FIG. 24 is a diagram illustrating a processing flow of input point moving processing according to moving tracks of a mouse;

FIG. 25 is a diagram illustrating a processing flow of input point moving processing using a mouse that allows two ways of operation;

FIG. 26 is a diagram illustrating a processing flow of structure highlighting processing;

FIG. 27 is a diagram illustrating a processing flow of physical property value information display processing of a structure;

FIG. 28 is a diagram illustrating a processing flow of display processing on a structure in the vicinity of an input point;

FIG. 29 is a diagram illustrating a processing flow of display processing on a line of intersection between the sketch plane in first guide display processing and a boundary plane of the structure;

FIG. 30 is a diagram illustrating a processing flow of display processing on a guideline from an input point to a structure in second guide display processing;

FIG. 31 is a diagram illustrating a processing flow of rotation display processing on a coordinate system in a virtual space;

FIG. 32 is a diagram illustrating a processing flow of structure data creation processing; and

FIG. 33 is a diagram illustrating an example of a hardware configuration of a three-dimensional data display apparatus.

### DETAILED DESCRIPTION OF THE PREFERRED EMBODIMENTS

Hereinafter, a three-dimensional data display system 1 disclosed as one embodiment of the present invention will be described.

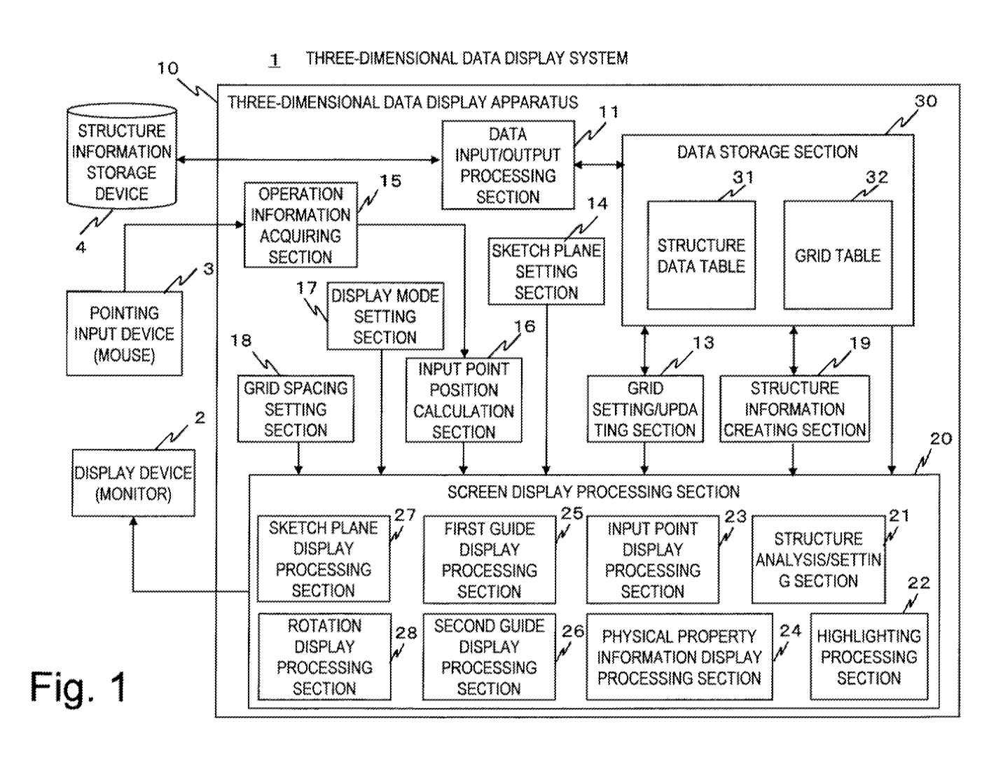

FIG. 1 is a diagram illustrating a configuration of the three-dimensional data display system 1 disclosed as one embodiment of the present invention. The three-dimensional data display system 1 illustrated in FIG. 1 is provided with a three-dimensional data display apparatus 10, a display device 2 and a pointing input device 3.

The three-dimensional data display apparatus 10 generates a display screen 100 (not illustrated) expressing a space in which a structure is arranged in a three-dimensional virtual space (hereinafter referred to as “virtual space”) of an orthogonal coordinate system and outputs the display screen 100 to the display device (monitor) 2.

Examples of structures processed by the three-dimensional data display apparatus 10 include members or parts such as substrate, circuit element, resistive element and wiring. The structure is displayed on the display screen 100 as a three-dimensional model generated based on three-dimensional structure information defined in a virtual space. The structure information includes structure information indicating the shape and position of the three-dimensional model of the structure and physical property value information indicating the material, conductivity or the like of the structure.

A user can move an input point Pt indicating a position in the virtual space where a predetermined grid is set on the display screen 100 by operating the pointing input device 3 of the three-dimensional data display system 1 to perform operation such as input and change of a wave source or circuit element at the position specified by the input point Pt.

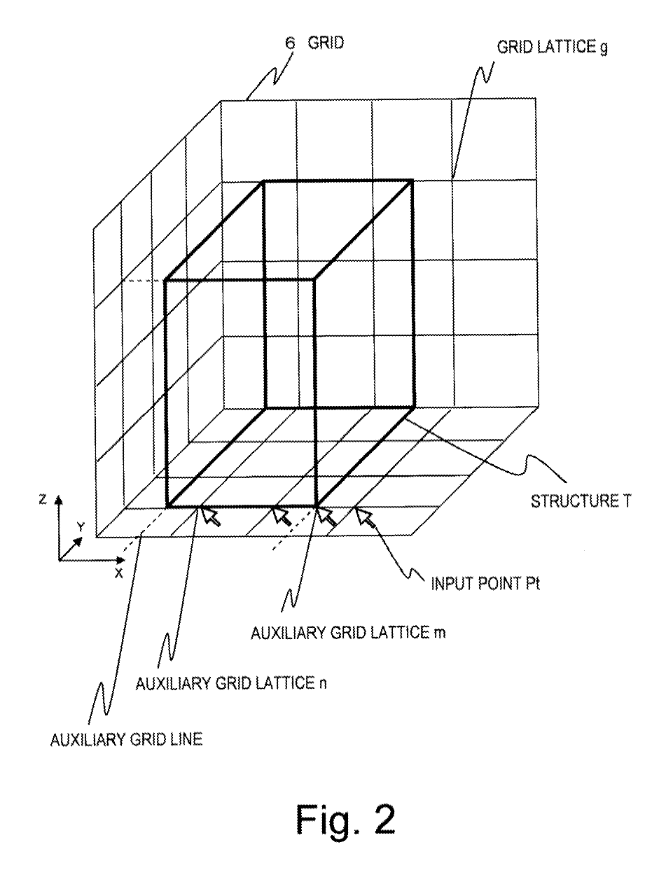

FIG. 2 is a diagram illustrating a grid set in the virtual space by the three-dimensional data display apparatus 10.

The grid 6 illustrated in FIG. 2 is a set of a plurality of coordinate points indicating a space defined as an analysis region in the virtual space handled by the three-dimensional data display apparatus 10. For example, an FDTD method defines the grid 6 as a divided analysis region, sets a calculation condition in units of each grid lattice of the grid 6 and performs analysis processing.

In FIG. 2, the grid 6 is represented by grid lines indicating grid spacing and a grid lattice g of the grid 6 is represented as a point of intersection between grid lines. Only some of grid coordinates are sown in the grid 6 of FIG. 2.

The three-dimensional data display apparatus 10 calculates coordinates gc in the virtual space of each grid lattice g of the grid 6. Furthermore, the three-dimensional data display apparatus 10 sets an auxiliary grid lattice m at a vertex of the structure arranged in the virtual space and further sets an auxiliary grid lattice n at a point of intersection between the boundary of the structure T and the grid line that makes up the grid 6. The three-dimensional data display apparatus 10 determines coordinates mc and nc of the auxiliary grid lattices m and n in the virtual space respectively.

When attention is focused on the bottom surface of the cubic structure T illustrated in FIG. 2, coordinates mc and nc of the auxiliary grid lattice m made up of four vertexes of the structure T and the auxiliary grid lattice n made up of twelve points of intersection are calculated.

The three-dimensional data display apparatus 10 calculates the moving destination of the input point Pt according to the moving direction and the amount of movement indicated by operation information generated through a moving operation of the pointing input device 3. White arrows illustrated in FIG. 2 indicate the input points Pt.

The three-dimensional data display apparatus 10 searches coordinates nearest to the moving destination of the input point Pt from coordinates gc, mc, nc of the grid lattice g, the auxiliary grid lattices m and n of the grid 6 and designates those coordinates as coordinates of the input point Pt that moves according to operation information. The three-dimensional data display apparatus 10 moves the input point Pt to a position indicating the searched coordinates and displays the input point Pt on the display screen 100. When, for example, the moving direction of the operation information is a negative direction of the X-axis of the virtual space, the input point Pt is controlled so as to move to the coordinates of any one of the grid lattice g, auxiliary grid lattices m, n according to the amount of movement of the operation information.

The pointing input device 3 is an input device operated by the user to move the input point Pt which indicates an arbitrary position in the virtual space. Any kind of device may be used as the pointing input device 3 as long as the device can input the moving direction and the amount of movement for moving the input point Pt in the virtual space. The pointing input device 3 can be realized by, for example, a mouse, keyboard, touch pad, touch panel or a combination thereof. The pointing input device 3 is preferably realized by a mouse in particular, which allows the input point Pt to be moved through operation by plane movement of the device and wheel rotation.

Though not illustrated in FIG. 1, the three-dimensional data display apparatus 10 can be connected to an input device such as a keyboard and an output apparatus such as a printer to input or output data.

The three-dimensional data display apparatus 10 is connected to a structure information storage device 4 to acquire information on the structure stored in the structure information storage device 4 (structure information) or transmit structure information generated to the structure information storage device 4. The structure information storage device 4 stores structure information created by adding physical property value information inputted or generated by another processing system to the structure information per structure created by a known CAD system.

Hereinafter, the processing operation of the three-dimensional data display apparatus 10 will be described schematically. It is assumed that the pointing input device 3 is realized by a mouse.

The three-dimensional data display apparatus 10 determines physical properties of a structure specified by the input point Pt, which is moved by the user according to the operation information of the mouse 3, from the physical property value information thereof (e.g., whether the structure is a metal or dielectric) and displays the structure in a highlighting color corresponding to the determined physical properties. This allows the user to recognize the physical properties of the specified structure by only viewing the display screen 100 and immediately judge whether the structure is a structure having physical properties to be processed (e.g., conductor).

Furthermore, the three-dimensional data display apparatus 10 generates a physical property value display screen that displays more detailed contents of the physical property value information of the structure specified by the user with the input point Pt and displays the screen on the monitor 2. This allows the user to immediately check physical property value information of the specified structure.

Furthermore, the three-dimensional data display apparatus 10 highlights the contours (boundary) of the structure specified by the user with the input point Pt. This allows the user to easily identify the boundary plane or boundary edge or the like of the specified structure and allows the user to specify the position of the structure on the boundary more easily.

Furthermore, the three-dimensional data display apparatus 10 sets and displays an arbitrary plane in the virtual space designated by the user as an operation reference as a sketch plane. Moreover, the three-dimensional data display apparatus 10 displays a guideline indicating a relationship between the sketch plane and the structure specified by the user.

To be more specific, the three-dimensional data display apparatus 10 displays the line of intersection between each boundary plane of the structure in the virtual space and the sketch plane on the display screen 100 as a first guide display. This allows the user to grasp the positional relationship of the structure arranged in the virtual space with reference to the sketch plane.

Furthermore, as the second guide display, the three-dimensional data display apparatus 10 displays a line segment on a line parallel to the orthogonal coordinate axis in the virtual space from the input point Pt to the point of intersection with the boundary plane of the structure as a guideline on the display screen 100. This allows the user to more easily grasp the distance from the input point Pt to the boundary of the structure.

Furthermore, the three-dimensional data display apparatus 10 moves the position of the input point Pt displayed on the display screen 100 with a predetermined grid spacing or a user-specified grid spacing according to the operation information from the mouse 3. Furthermore, the three-dimensional data display apparatus 10 moves the input point Pt to a vertex of the structure in the virtual space or a point of intersection between the boundary of the structure and the grid lattice. That is, the input point Pt on the display screen 100 is always controlled so as to move to any one of the grid lattice set by the basic grid 6, a vertex of the structure and a position on the boundary plane.

For example, in a setting operation of the input position of a wave source or circuit terminal, when the user operates the mouse 3, the position of contact with the grid lattice g or the boundary of the structure is indicated by the input point Pt, and therefore the user's burden of inputting the positions of contact with the structure is drastically reduced and errors in the position setting can be avoided.

Furthermore, the three-dimensional data display apparatus 10 can control the space moving direction that can be inputted by the mouse 3 in association with the sketch plane specified by the user in the virtual space. To be more specific, when the moving direction of the input point Pt can be inputted through two ways of operation of plane movement and wheel rotation using the mouse 3, the movement of the input point Pt can be controlled by performing the association between the moving direction of plane movement and the two coordinate axes that identify the sketch plane and the association between the moving direction in wheel rotation and the coordinate axis perpendicular to the sketch plane.

This allows the user to grasp the operation of plane movement of the mouse 3 in association with the control of the movement of the input point Pt on the sketch plane of the display screen 100 and further grasp the operation of wheel rotation in association with the control of the movement in the direction orthogonal to the sketch plane and allows the user to operate the input point Pt on the display screen 100 more easily.

Furthermore, the three-dimensional data display apparatus 10 rotates the orthogonal coordinate system of the virtual space based on the axis of rotation and the angle of rotation inputted and specified by the user and displays the orthogonal coordinate system on the display screen 100.

Thus, even if the user specifies an inclined plane in the original virtual space as the sketch plane, the entire virtual space is displayed as an orthogonal coordinate system with reference to the sketch plane, and therefore visibility of the virtual space increases and convenience of the user operation can be improved.

In order to perform the above described processing, the three-dimensional data display apparatus 10 is provided with a data input-output processing section 11, a grid setting-updating section 13, a sketch plane setting section 14, an operation information acquiring section 15, an input point position calculation section 16, a display mode setting section 17, a grid spacing setting section 18, a structure information creating section 19, a screen display processing section 20, and a data storage section 30.

The data input-output processing section 11 stores structure information acquired from the structure information storage device 4 in the data storage section 30 or transmits structure information of the data storage section 30 to the structure information storage device 4.

The grid setting-updating section 13 sets the grid 6 which becomes the basis in the virtual space based on a predetermined grid spacing and calculates coordinates gc of each grid lattice g in the virtual space based on the set grid 6.

Furthermore, based on the structure information, the grid setting-updating section 13 designates the vertex of the structure in the virtual space as an auxiliary grid lattice m, determines the point of intersection between the boundary of the structure and the grid 6 and designates the point of intersection obtained as an auxiliary grid lattice n. The grid setting-updating section 13 then calculates coordinates mc and nc of the auxiliary grid lattice m and the auxiliary grid lattice n in the virtual space respectively and registers the coordinates with the data storage section 30.

Furthermore, when an additional setting or a change is made to a structure in the virtual space, wave source, circuit terminal or the like, the grid setting-updating section 13 identifies the auxiliary grid lattices m and n from the structure information of the added or changed structure, calculates the coordinates mc and nc and adds the coordinates to the data storage section 30.

The sketch plane setting section 14 sets the sketch plane set based on the user's input specification in the virtual space. The sketch plane is a plane used by the user as an operation reference and is a limited plane in the virtual space, that is, a plane having a finite area. When there is a boundary plane of the structure at the position of the input point Pt, the sketch plane setting section 14 sets the plane including the boundary plane as the sketch plane from the structure in the virtual space.

The operation information acquiring section 15 detects the movement of the mouse 3 and acquires operation information indicating the moving direction and amount of movement of the input point Pt and instruction information of specification or selection by left or right click or the like.

The input point position calculation section 16 calculates and stores the coordinates of the input point Pt of the virtual space. Furthermore, the input point position calculation section 16 calculates the moving destination of the input point Pt based on the operation information acquired by the operation information acquiring section 15. The input point position calculation section 16 then selects coordinates at the shortest distance from the moving destination of the input point Pt from among the coordinates gc, mc and nc of the grid lattice g, auxiliary grid lattices m and n stored in the data storage section 30 and updates the coordinates of the input point Pt with the selected coordinates.

When a sketch plane is set in the virtual space, the input point position calculation section 16 performs the association between the coordinate axis indicating the moving direction that can be inputted through the operation of plane movement of the mouse 3 and the coordinate axis that identifies the sketch plane and the association between the coordinate axis indicating the moving direction that can be inputted through the operation of wheel rotation of the mouse 3 and the coordinate axis in the direction perpendicular to the sketch plane and stores association information that indicates the associations. The input point position calculation section 16 then calculates the moving destination of the input point Pt from the operation information acquired based on this association information.

The display mode setting section 17 sets the display mode to any one of a space fixing mode in which display is performed by fixing the virtual space of the display screen 100 and moving the position of the input point Pt as the input point Pt moves according to the operation information, and an input point fixing mode in which display is performed by fixing the position of the input point Pt and moving the display region of the virtual space.

The grid spacing setting section 18 sets grid spacing processed by the grid setting-updating section 13 through user specification.

The screen display processing section 20 calculates the boundary line and boundary plane or the like of the structure arranged in the virtual space based on the structure information stored in the data storage section 30, arranges the structure in the virtual space, generates the display screen 100 on which the structure arranged is displayed based on the property value information of the structure and displays the display screen 100 on the monitor 2. Furthermore, the screen display processing section 20 generates the display screen 100 based on the display mode (space fixing mode/input point fixing mode) set by the display mode setting section 17.

The screen display processing section 20 is provided with a structure analysis-setting section 21, a highlighting processing section 22, an input point display processing section 23, a physical property information display processing section 24, a first guide display processing section 25, a second guide display processing section 26, a sketch plane display processing section 27 and a rotation display processing section 28.

The structure analysis-setting section 21 acquires structure information of the structure located in the virtual space displayed on the display screen 100 from the structure information stored in the data storage section 30, arranges the structure in the virtual space based on the acquired structure information and displays the structure on the display screen 100. Furthermore, the structure analysis-setting section 21 identifies the structure located within a predetermined range from the position (coordinates) of the input point Pt in the virtual space displayed on the display screen 100 and displays only the identified structure on the display screen 100.

The highlighting processing section 22 sets a display mode corresponding to the physical property value information indicating physical properties (material in particular) of the structure, for example, display color, kind of line or line width of contours beforehand and highlights the structure arranged in the virtual space of the display screen 100 with a display mode corresponding to the physical properties of the structure based on the structure information.

Furthermore, the highlighting processing section 22 refers to the physical property value information of the structure information of the data storage section 30 and displays the information on the display screen 100 by highlighting only a structure having specific physical properties.

Furthermore, the highlighting processing section 22 identifies a structure, in the region of which the coordinates of the input point Pt are located, and displays the identified structure on the display screen 100 in a predetermined display mode, for example, by drawing contours thereof with a thick line or coloring the contours in a highlighting color corresponding to the physical properties.

The input point display processing section 23 displays the input point Pt at the coordinates after the virtual space is updated every time the coordinates of the input point Pt are updated.

The physical property information display processing section 24 refers to structural information of the structure information of the data storage section 30, generates a structure list screen 150 for listing physical properties of the structure in the virtual space, displays the structure list screen 150 on the monitor 2, generates a physical property value information screen 155 that displays the physical property value information of the structure selected by the user on the structure list screen 150 and displays the physical property value information screen 155 on the monitor 2.

The first guide display processing section 25 calculates the line of intersection between the boundary plane of the structure of the virtual space and the sketch plane based on the structure information and displays the calculated line of intersection on the display screen 100.

Based on the structure information, the second guide display processing section 26 displays straight lines in three directions indicating the respective coordinate axes of the virtual space from the coordinates of the input point Pt, which are line segments up to the point of intersection with the boundary plane of the nearest structure on the display screen 100 as guidelines.

The sketch plane display processing section 27 displays the sketch plane set in the virtual space on the display screen 100.

The rotation display processing section 28 generates a rotation coordinate system resulting from rotating the rotation coordinates selected from the coordinate axis of the orthogonal coordinate system of the virtual space by an angle of rotation specified by the user and displays the virtual space according to the rotation coordinate system on the display screen 100.

The data storage section 30 is a storage that stores data processed by the three-dimensional data display apparatus 10. The data storage section 30 stores, for example, a structure data table 31 that stores structure information and a grid table 32 that stores the coordinates gc, mc and nc of the grid lattice g, and auxiliary grid lattices m and n.

The structure data table 31 stores structure information indicating the shape and arrangement of each structure and physical property value information indicating material, dielectric constant, conductivity or the like.

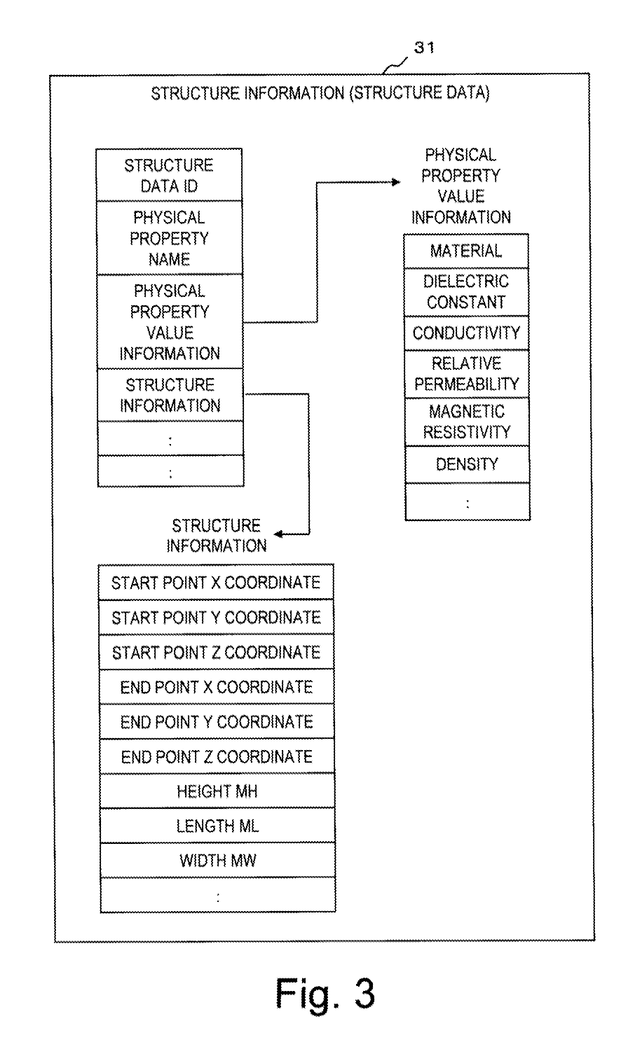

FIG. 3 is a diagram illustrating data item examples of the structure data table 31.

The structure data table 31 includes data items such as structure data ID, physical property name, physical property value information and structure information for each piece of structure data.

The structure data ID is an identification number that uniquely defines a model of each structure.

The physical property name is the name of a structure, and a name indicating physical properties such as copper A, copper B, dielectric A is used in the example illustrated in FIG. 3.

The physical property value information is a specific value indicating physical properties of a structure and further includes information on the name of material (material) corresponding to each of the physical property name, physical quantity corresponding to dielectric constant, conductivity, relative permeability, magnetic resistivity, density.

The structure information is information on coordinate values indicating the position and shape of a structure within a predetermined structure. When, for example, a structure model having a rectangular parallelepiped external shape is defined, the structure information includes information on the position and size (shape) such as the start point X coordinate, start point Y coordinate, start point Z coordinate, end point X coordinate, end point Y coordinate, end point Z coordinate, height MH, length ML, width MW. The data items of the structure information of the structure data table 31 can be changed as appropriate according to the shape of the structure.

The structure information creating section 19 generates structure data such as a structure, circuit elements additionally arranged in the virtual space or updates the structure data whose arrangement or the like is changed through the user's operation. For example, the structure information creating section 19 generates, when the user adds a structure specified by the input point Pt on the display screen 100, structure information based on control points or the like inputted at the input point Pt, further generates physical property value information based on the user's input instruction, creates structure data including this structure information and physical property value information and stores the structure data in the structure data table 31.

Hereinafter, processing by the three-dimensional data display apparatus 10 will be described.

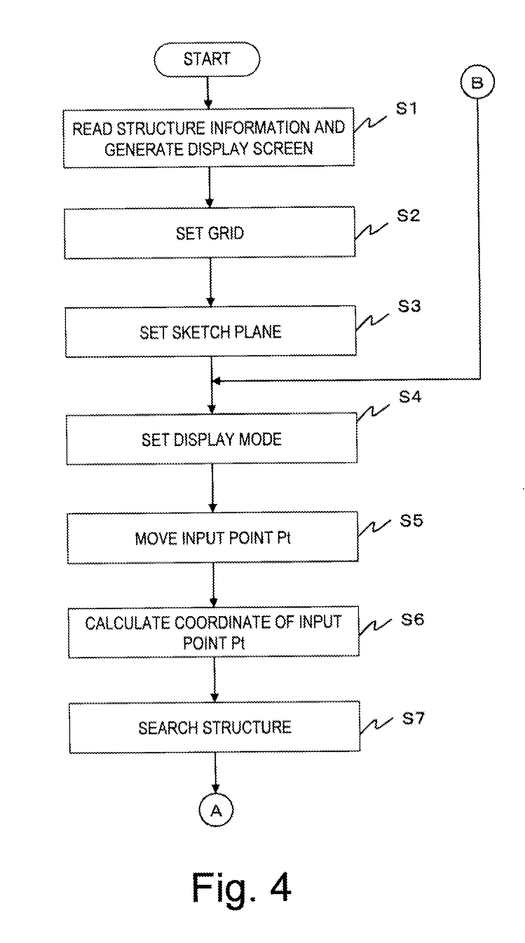

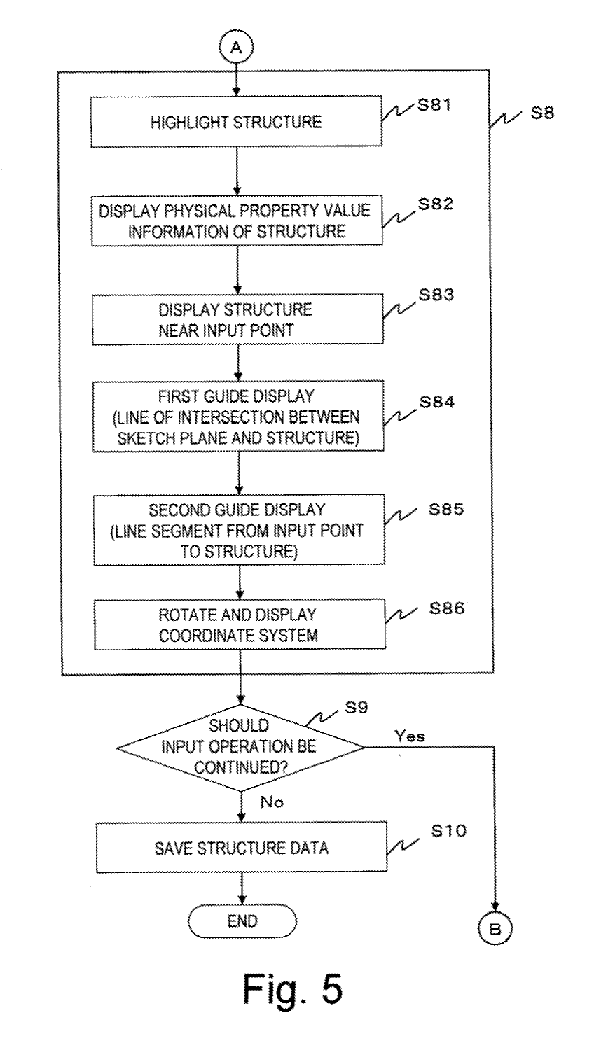

FIG. 4 and FIG. 5 are diagrams illustrating an overview of a processing flow of the three-dimensional data display apparatus 10 according to the embodiment.

Step S1: Structure Information Reading Processing and Display Screen Generation Processing

The data input-output processing section 11 of the three-dimensional data display apparatus 10 reads structure information (structure data) of a structure to be processed from the structure information storage device 4 and stores the structure information in the structure data table 31 of the data storage section 30.

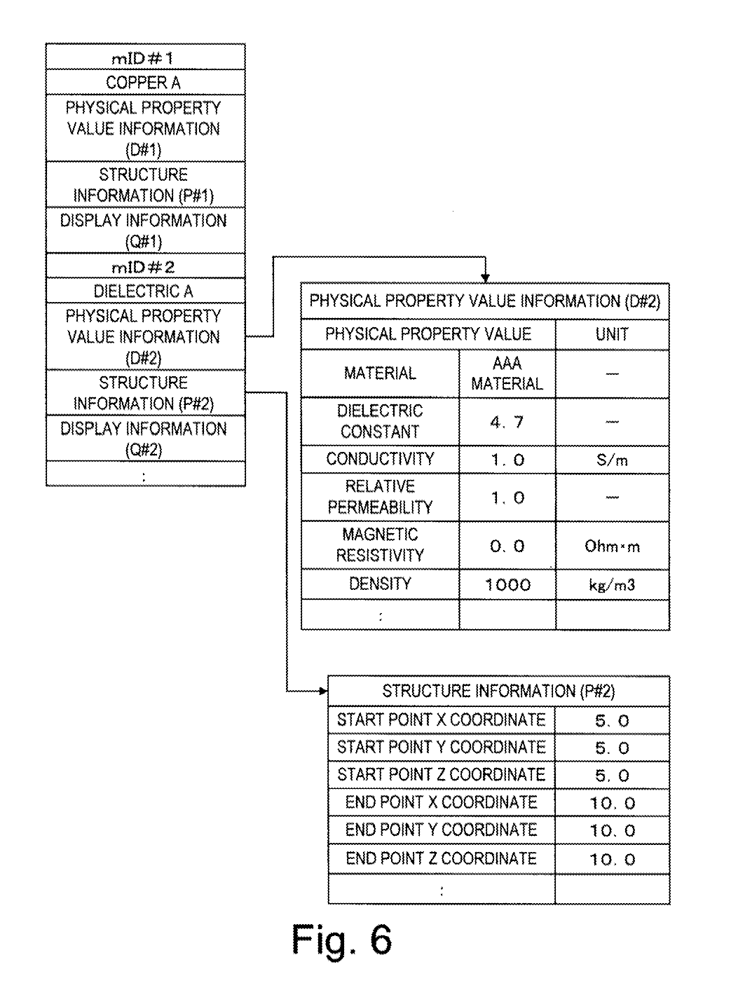

FIG. 6 illustrates an example of structure data stored in the structure data table 31.

The structure data table 31 illustrated in FIG. 6 stores structure data of structures mID#1, mID#2, . . . . An item “D#2” of physical property value information of the structure data of the structure mID#2 is a pointer to the physical property value information of the structure mID#2 and an item “P#2” of the structure information indicates that it is a pointer to the structure information of the structure mID#2.

The physical property value information (D#2) of the structure mID#2 stores data such as material “AAA material,” dielectric constant “4.7,” conductivity “1.0.” The structure information (P#2) of the structure mID#2 stores data such as start point x coordinate “5.0,” start point y coordinate “5.0.”

The structure analysis-setting section 21 selects a structure to be arranged in a region of a virtual space displayable on the display screen 100 generated by the screen display processing section 20 based on the structure data of the structure data table 31. The structure analysis-setting section 21 calculates the shape and position in the virtual space of each selected structure, arranges the structure in the virtual space and displays the structure on the display screen 100. The structure analysis-setting section 21 may also be configured to determine the region of the virtual space displayed on the display screen 100 based on user specification.

Next, the three-dimensional data display apparatus 10 performs processing in following step S2 and step S3 as initial setting processing.

Step S2: Grid Setting Processing

The grid setting-updating section 13 displays a grid spacing setting screen 120 on the monitor 2 and when each value of grid spacing is inputted on the grid spacing setting screen 120, the grid setting-updating section 13 sets the input value as grid spacing. The grid setting-updating section 13 can store the initial value of grid spacing.

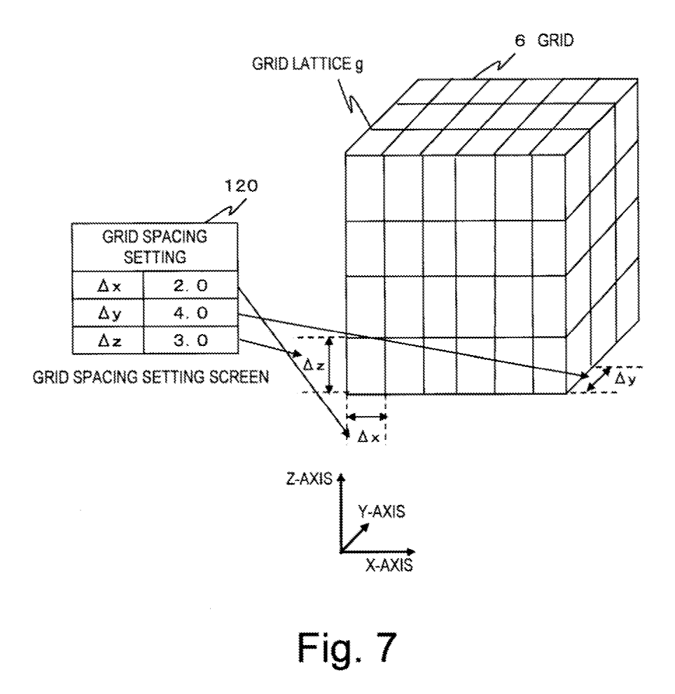

FIG. 7 is a diagram illustrating a setting example of grid spacing.

When set values of X-axis direction grid spacing Δx=2.0, Y-axis direction grid spacing Δy=4.0 and Z-axis direction grid spacing Δz=3.0 are inputted on the grid spacing setting screen 120, the grid setting-updating section 13 sets the grid 6 in the virtual space based on the set values. Through this processing, the grid 6 is defined in the virtual space using the X-axis, Y-axis and Z-axis as coordinate axes as illustrated in FIG. 7.

Furthermore, the grid setting-updating section 13 calculates coordinates gc of each grid lattice g of the grid 6 in the virtual space and stores the coordinates gc in the grid table 32. Next, the grid setting-updating section 13 identifies the structure to be arranged in the virtual space, calculates the shape and the position in the virtual space of the identified structure and designates the vertex of the structure, points of intersection between the boundary of the structure and the grid 6 as auxiliary grid lattices m and n. Furthermore, the grid setting-updating section 13 calculates coordinates mc and nc of the calculated auxiliary grid lattices m and n in the virtual space and stores the coordinates mc and nc in the grid table 32.

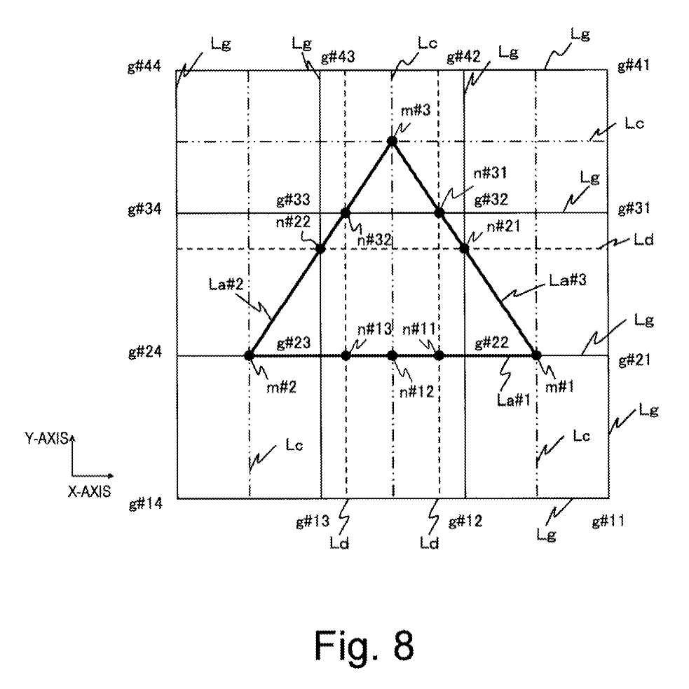

FIG. 8 is a diagram illustrating a setting example of the grid lattice g and auxiliary grid lattices m and n on one plane (e.g., bottom surface) of the structure T arranged in the virtual space.

For simplicity of explanation, a case will be described in the example illustrated in FIG. 8 where the structure T has a triangle pole shape, and as the plane corresponding to the bottom surface thereof, a plane whose Z coordinate is fixed, that is, the XY plane fixed at the Z coordinate of the coordinates gc of the grid lattice g will be described.

The grid setting-updating section 13 sets the grid 6 based on the grid spacing in the virtual space, calculates the coordinates gc based on each grid lattice g (g#11 to g#14, g#21 to g#24, g#31 to g#34, g#41 to g#44) and stores each grid lattice g in the grid table 32.

When the structure T is arranged in the virtual space, the grid setting-updating section 13 determines, from the structure data of the structure T arranged, whether or not each vertex of the structure T is located on the grid lattice g. The grid setting-updating section 13 sets auxiliary grid lattices m (m#1, m#2, m#3) at vertexes not located on the grid lattice g out of the vertexes of the structure T, designate the coordinate value of the vertex as coordinates mc and adds the coordinates mc to the grid table 32. For example, regarding the vertex m#1, grid ID=m#1, coordinates (x#i1, y#i1, z#11) are stored in the grid table 32 (i represents an integer).

Grid auxiliary lines Lc illustrated in FIG. 8 are illustrated for a reference and are lines parallel to grid lines Lg of the grid 6 that pass through the auxiliary grid lattices m#1 to m#3 corresponding to the vertexes of the structure T.

Furthermore, the grid setting-updating section 13 calculates points of intersection between boundary lines La#1 to La#3 of the structure T and the grid lines Lg and sets auxiliary grid lattices n at the points of intersection. Furthermore, the grid setting-updating section 13 calculates points of intersection between the boundary lines La#1 to La#3 of the structure T and the grid auxiliary lines Lc and Ld that pass through the auxiliary grid lattices m and n and also sets auxiliary grid lattices n at the points of intersection. The grid setting-updating section 13 then calculates coordinates nc based on the respective auxiliary grid lattices n (n#11 to n#13, n#21 to n#22, n#31 to n#32) and stores the coordinates nc in the grid table 32. For example, regarding the point of intersection n#11, grid ID=n#11, coordinates (x#i4, y#i4, z#11) are stored in the grid table 32.

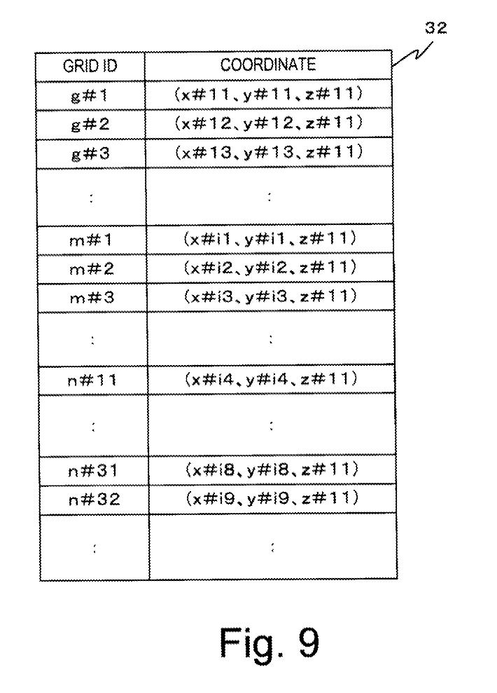

FIG. 9 illustrates a data configuration example of the grid table 32 according to the embodiment.

The grid table 32 is a table that stores grid coordinates or grid IDs of respective auxiliary grid coordinates and coordinate values identified in the grid 6 defined for an analysis region in the virtual space.

The grid ID is identification information uniquely set for each grid lattice and auxiliary grid lattice m, n of the grid 6. The coordinate values are coordinate values (x, y, z) in the virtual space (X-axis, Y-axis, Z-axis) of coordinates gc, mc, nc.

As illustrated in FIG. 9, the grid table 32 stores grid coordinates (x#11, y#11, z#11) associated with the grid ID=g#1, grid coordinates (x#12, y#12, z#11) and (x#13, y#13, z#11) associated with the grids ID=g#2 and g#3 or the like.

Step S3: Sketch Plane Setting Processing

The sketch plane setting section 14 sets a sketch plane based on the user's specification.

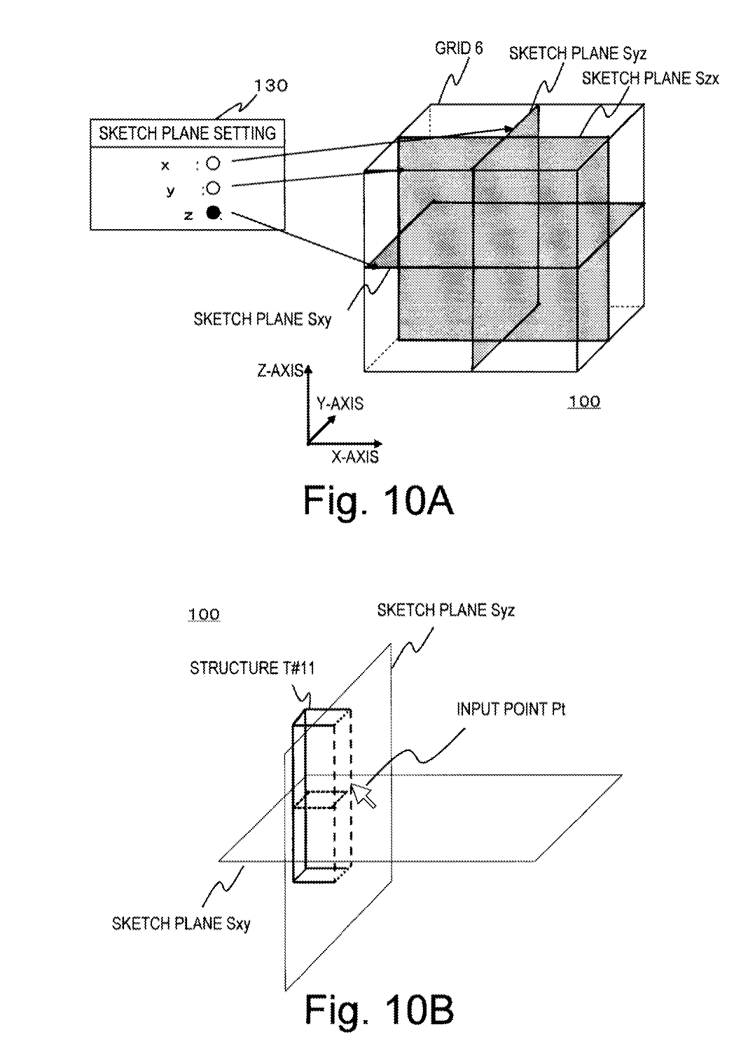

FIGS. 10A and 10B illustrate a sketch plane setting and sketch plane.

FIG. 10A illustrates a case of a sketch plane setting through input specification on a setting screen.

In FIG. 10A, any one of planes in the three directions (illustrated in a perspective view) set as the sketch planes is selected by the input point Pt in the virtual space on a sketch plane setting screen 130.

Suppose sketch planes Sxy, Syz and Szx are displayed on the sketch plane setting screen 130 in the directions of the normal (directions perpendicular to the sketch plane).

The sketch plane setting section 14 sets the sketch plane according to the set content selected by the sketch plane setting screen 130 displayed on the monitor 2. For example, when “display z” is selected (illustrated by a black circle) on the sketch plane setting screen 130, the sketch plane setting section 14 sets a sketch plane Sxy which is a plane including the position (coordinates) of the input point Pt as illustrated in FIG. 10B and is an XY plane within the virtual space corresponding to “display z.” Likewise, the sketch plane setting section 14 sets a sketch plane Syz which is a YZ plane when “display x” is selected on the sketch plane setting screen 130 and sets a sketch plane Szx which is a ZX plane when “display y” is selected.

These sketch planes may also be controlled so as to move in the direction of the normal to the plane in conjunction with the coordinates of the input point Pt. For example, the sketch plane Sxy (XY plane) illustrated in FIG. 10A moves in the Z axis direction which is the direction of the normal as the input point Pt moves. As a result, the sketch plane on the display screen 100 is set as a plane including the position (coordinates) of the input point Pt after movement.

Furthermore, the sketch plane may also be set using a structure. As illustrated in FIG. 10B, in a structure T#11 displayed on the display screen 100, suppose the position of an input point Pt is located on one boundary plane of the structure T#11.

When “display x” is selected on the sketch plane setting screen 130, the sketch plane setting section 14 sets the sketch plane Syz which is a YZ plane including this boundary plane of the structure T#11.

Next, the three-dimensional data display apparatus 10 performs processing in step S4 and step S5 as processing based on the operation of the mouse 3.

Step S4: Display Mode Setting Processing

The display mode setting section 17 provides a space fixing mode and an input point fixing mode as display modes of the display screen 100, switches, upon receiving an instruction input of the display mode from the mouse 3, the display mode setting of the display screen 100 and reports the display mode setting to the image display processing section 20. The display mode is a mode of display processing when the position of the input point Pt is updated and displayed as the input point Pt moves.

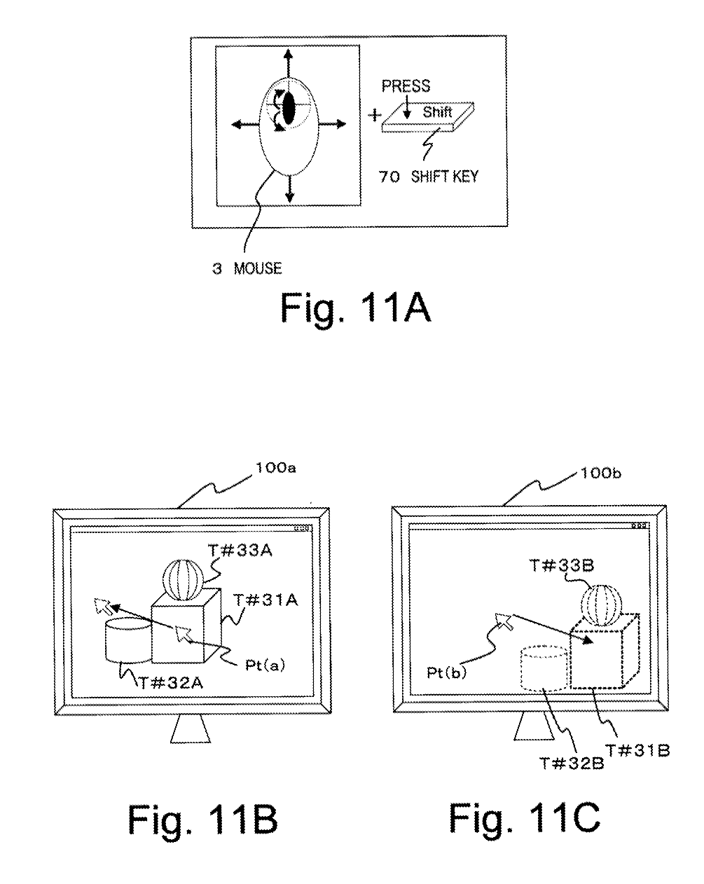

FIGS. 11A, 11B and 11C illustrate switching of the display mode setting.

As illustrated in FIG. 11A, when information on pressing of a predetermined key to which an instruction for switching the scroll display mode is assigned or clicking such as pressing of a Shift key 70 of the keyboard simultaneous with the moving operation of the mouse 3 is received via the operation information acquiring section 15, the display mode setting section 17 reports the mode switching whereby the current display mode is switched to another display mode to the screen display processing section 20.

Here, the display mode is alternately switched between two display modes; a space fixing mode and an input point display mode, and the screen display processing section 20 generates the display screen 100 based on the display mode set by the display mode setting section 17.

The space fixing mode is a display mode in which a structure arranged in the virtual space and the grid 6 are fixed and displayed by moving the position of the input point Pt. As illustrated in FIG. 11B, the positions of structures T#31A to T#33A displayed on a display screen 100a of the monitor 2 are fixed and an input point Pt(a) is moved and displayed as the mouse 3 moves.

The input point fixing mode is a display mode in which the input point Pt is displayed by fixing the position thereof, and a structure arranged in the virtual space and the grid 6 are displayed by relatively moving them. As illustrated in FIG. 11C, the position of an input point Pt(b) displayed on a display screen 100b of the monitor 2 is fixed and structures T#31B to T#33B in the virtual space are displayed by being moved as the mouse 3 moves.

Such switching between display modes facilitates the movement operation of the input point Pt by the user when part of the virtual space is displayed in an enlarged view or the like.

Step S5: Input Point Pt Movement

Every time the information acquiring section 15 detects the operation of the mouse 3, the information acquiring section 15 acquires operation information including the moving direction and amount of movement (moving distance) generated by the moving operation of the mouse 3 and transmits the operation information to the input point position calculation section 16.

The input point position calculation section 16 calculates the moving destination in the virtual space from the position (coordinates) of the input point Pt based on the moving direction and moving distance of operation information. The input point position calculation section 16 then selects coordinates nearest to the calculated moving destination from the coordinates gc, mc and nc stored in the grid table 32 and uses the coordinates as the position (coordinates) after the movement of the input point Pt.

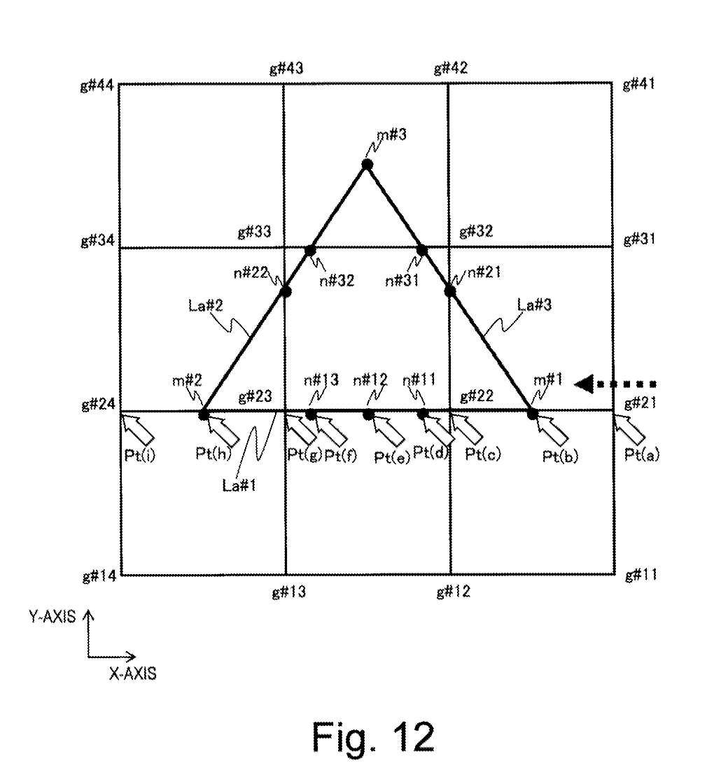

FIG. 12 is a diagram illustrating movement of the input point Pt.

FIG. 12 shows one plane of the virtual space. On the plane in FIG. 12, grid axes of the grid 6 set with grid spacing are illustrated by thin lines and the boundary plane of the structure of a triangle pole shape arranged in the virtual space is illustrated by thick lines La#1 to La#3. Furthermore, in FIG. 12, suppose each grid lattice g (g#11 to g#44), auxiliary grid lattice m (m#1 to m#3) and auxiliary grid lattice n (n#11 to n#32) of the grid 6 are the same as those in the example illustrated in FIG. 8.

In FIG. 12, suppose the input point Pt before the operation of the mouse 3 is located at the position of the grid coordinates g#21 (illustrated by input point Pt(a) in the figure) and the user operates the mouse 3 so as to move in the direction illustrated by the broken line arrow (parallel to the negative direction of the X-axis).

The input point position calculation section 16 calculates the moving direction and the moving distance of the input point Pt based on the operation information of the mouse 3 and calculates the moving destination. The input point position calculation section 16 selects the coordinates mc of the auxiliary grid coordinates m#1 nearest to the moving destination of the input point Pt calculated from the grid table 32 and designates the coordinates mc as the coordinates of input point Pt after the movement (illustrated by input point Pt(b) in the figure).

Furthermore, when the acquisition of the operation information from the mouse 3 continues, the input point position calculation section 16 likewise calculates the moving destination of the input point Pt according to the moving distance included in the next acquired operation information and designates the coordinates gc of the grid coordinates g#22 nearest to the moving destination as the coordinates of the input point Pt after the movement (illustrated by input point Pt(c) in the figure).

Thus, while acquiring the operation information from the mouse 3 continuously, the input point position calculation section 16 calculates the moving destination of the input point Pt based on the sequentially acquired operation information, selects the coordinates nearest to the moving destination from the grid table 32 and designates the coordinates as the coordinates of the input point Pt after the movement. As a result, the input point Pt is controlled so as to move positions from the position before the operation (grid lattice g#21) to the auxiliary grid lattice m#1→grid lattice g#→auxiliary grid lattice n#11→auxiliary grid lattice n#12→auxiliary grid lattice n#13→grid lattice g#23→auxiliary grid lattice m#2→grid lattice g#24.

Every time the coordinates of the input point Pt move, the input point display processing section 23 displays the input point Pt (illustrated as Pt(a)→Pt(b)→Pt(c)→Pt(d)→Pt(e)→Pt(f)→Pt(g)→Pt(h)→Pt(i) in the figure) at positions corresponding to the coordinates after the movement of the display screen 100.

Furthermore, as another method of moving the input point Pt, the input point position calculation section 16 can control the movement of the input point Pt using moving tracks without using the grid table 3. In this case, the grid table 32 of the data storage section 30 is not necessary.

To be more specific, the input point position calculation section 16 calculates moving tracks of the input point Pt from the moving direction included in the operation information. The input point position calculation section 16 then determines, based on the structure data table 31, whether the boundary of the grid 6 or the structure exists on the moving tracks. If the boundary plane of the grid 6 or the structure exists, the input point position calculation section 16 calculates a point of intersection between the moving tracks and the boundary plane of the structure and designates the calculated point of intersection as the coordinates of the input point Pt after the movement.

In FIG. 12, for example, suppose the position of the input point Pt before operating the mouse 3 is the position of the grid coordinates g#21 (illustrated by input point Pt(a) in the figure) and the user operates the mouse 3 so as to move the input point Pt in the direction of the broken line arrow (parallel to the negative direction of the X-axis).

The input point position calculation section 16 calculates a moving track from the moving direction of operation information generated by the operation of the mouse 3. Suppose this moving track is a straight line directed from the grid coordinates g#21 toward the grid coordinates g#24. In this case, the input point position calculation section 16 determines whether or not any boundary of the structure T exists on the moving track, designates the point of intersection which is the boundary of the structure T on the moving track (equivalent to the coordinates illustrated by the auxiliary grid lattice m#1) as the coordinates of the input point Pt after the movement and moves the input point Pt to the coordinates. Furthermore, when the moving track calculated from the moving direction of the next operation information is the same, the input point position calculation section 16 determines the coordinates gc of the grid lattice g#22 that exists on the same moving track, moves the input point Pt further to the grid lattice g#23 that exists on the same track, the point of intersection with the boundary of the structure T (equivalent to the coordinates of the auxiliary grid lattice m#2) and the coordinates of the grid lattice g#24.

Every time the position of the input point Pt moves, the input point display processing section 23 displays the input point Pt (Pt(a)→Pt(b)→Pt(c)→Pt(g)→Pt(h)→Pt(i) in the figure) at the positions corresponding to the coordinates of the display screen 100 after the movement.

Such processing allows the user to efficiently move the input point Pt by operating the mouse 3 and perform precise alignment.

Next, as a further method of moving the input point Pt, the control of movement of the input point Pt using the mouse 3 that allows two ways of moving operation and the sketch plane will be described.

When two moving operations of plane movement and wheel rotation using the mouse 3 are possible, the operation information acquiring section 15 acquires the operation information from the mouse 3 through plane movement (first operation information) and the operation information through wheel rotation (second operation information) distinctively from each other. The input point position calculation section 16 performs processing by limiting the moving direction included in the first operation information to movement on the sketch plane and processes the moving direction included in the second operation information as movement in the direction perpendicular to the sketch plane.

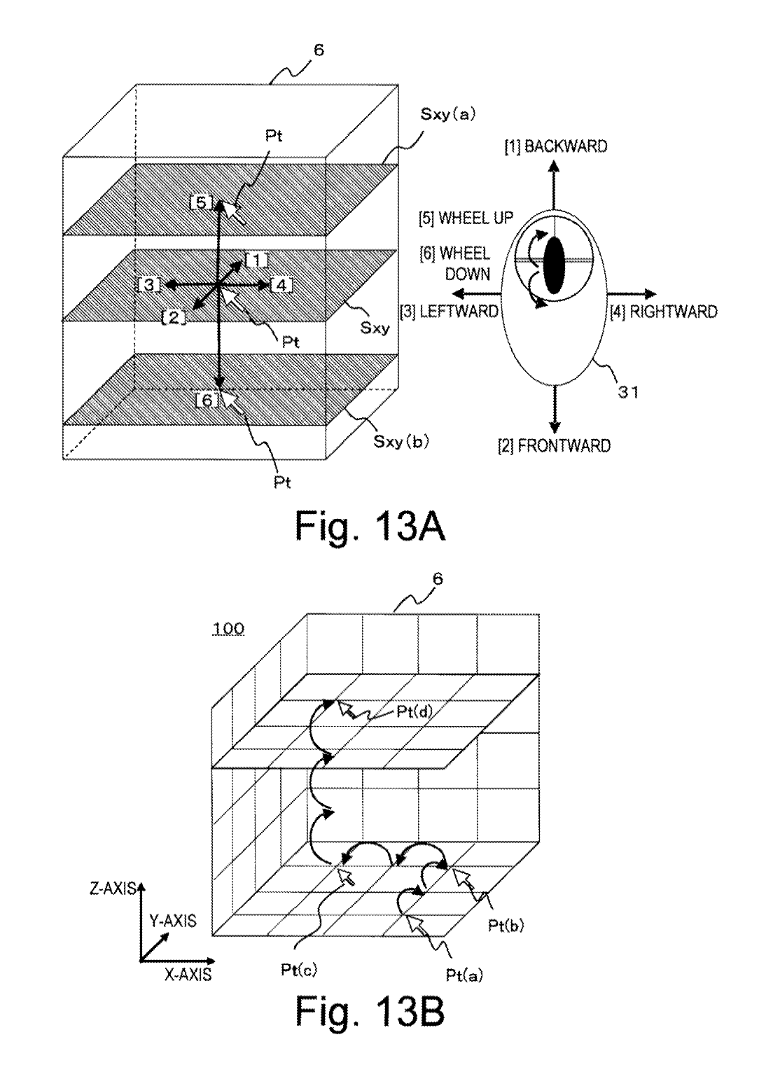

In FIG. 13A, suppose the coordinates of the input point Pt are located on the sketch plane Sxy (XY plane of the virtual space).

When the operation information acquiring section 15 acquires the first operation information from the mouse 3, the input point position calculation section 16 associates the moving direction included in the first operation information with the X-axis direction or Y-axis direction of the sketch plane Sxy and moves the input point Pt. Furthermore, when the operation information acquiring section 15 acquires the second operation information from the mouse 3, the input point position calculation section 16 associates the rotation direction of the wheel rotation included in the second operation information with the Z-axis direction which is the normal of the sketch plane Sxy and moves the input point Pt.

To be more specific, as illustrated in FIG. 13A, when the mouse 3 moves toward any one direction of direction 1 (backward direction), direction 2 (frontward direction), direction 3 (leftward direction) and direction 4 (rightward direction) through the plane operation, the movement of the mouse 3 in direction 1 or direction 2 is associated with the movement of the input point Pt in the Y-axis direction on the sketch plane Sxy and the movement of the mouse 3 in direction 3 or direction 4 is likewise associated with the movement in the X-axis direction. Furthermore, the moving distance in each direction is determined by the amount of movement of the first operation information and the coordinates of the input point Pt after the movement are uniquely identified.

Furthermore, through wheel rotation of the mouse 3, the rotation of the mouse wheel in direction 5 (upward direction) or direction 6 (downward direction) is associated with the movement in the Z-axis direction which is the direction of the normal of the sketch plane Sxy of the input point Pt. The moving distance in the Z-axis direction is determined by the amount of movement of the second operation information and the coordinates of the input point Pt after the movement are uniquely identified.

When the sketch plane is the YZ plane, the moving direction of the plane operation corresponds to the Y-axis or Z-axis direction of the virtual space and the moving direction of the wheel rotation corresponds to the X-axis direction. Likewise, when the sketch plane is the ZX plane, the moving direction of the plane operation corresponds to the Z-axis or X-axis direction and the moving direction of the wheel rotation corresponds to the Y-axis direction.

Thus, as illustrated in FIG. 13B, the position of the input point Pt moves in moving order of, for example, Pt(a)→Pt(b)→Pt(c)→Pt(d) on the grid coordinates of the virtual space of the display screen 100 according to the moving direction and the amount of movement of the mouse 3.

This allows the user to more easily grasp the relativity between the position of the input point Pt and the operation of the mouse 3, and can thereby improve operation efficiency.

Step S6: Calculation of Input Point Coordinates

Every time the input point Pt moves, the input point position calculation section 16 calculates the coordinates of the input point Pt in the virtual space.

Step S7: Structure Search Processing

With reference to the structure data table 31, the structure analysis-setting section 21 judges whether or not the coordinates of the input point Pt are located in the region of the structure arranged in the virtual space and identifies the structure whose region includes the coordinates of the input point Pt.

Step S8: Display Processing

In the screen display control section 20, each processing section performs the display processing in following steps S81 to S86 based on the user's input instruction or selection.

Step S81: Highlighting Processing

The highlighting processing section 22 identifies a structure whose region is located at the coordinates of the input point Pt from the structure data table 31, and displays one or both of the identified boundary line and boundary plane of the structure in a predetermined highlighted manner, for example, displays the boundary line with a highlighted line (e.g., line types “solid line”, line width “1.5p”) or displays the boundary plane of the structure in a predetermined display color (e.g., “blue”).

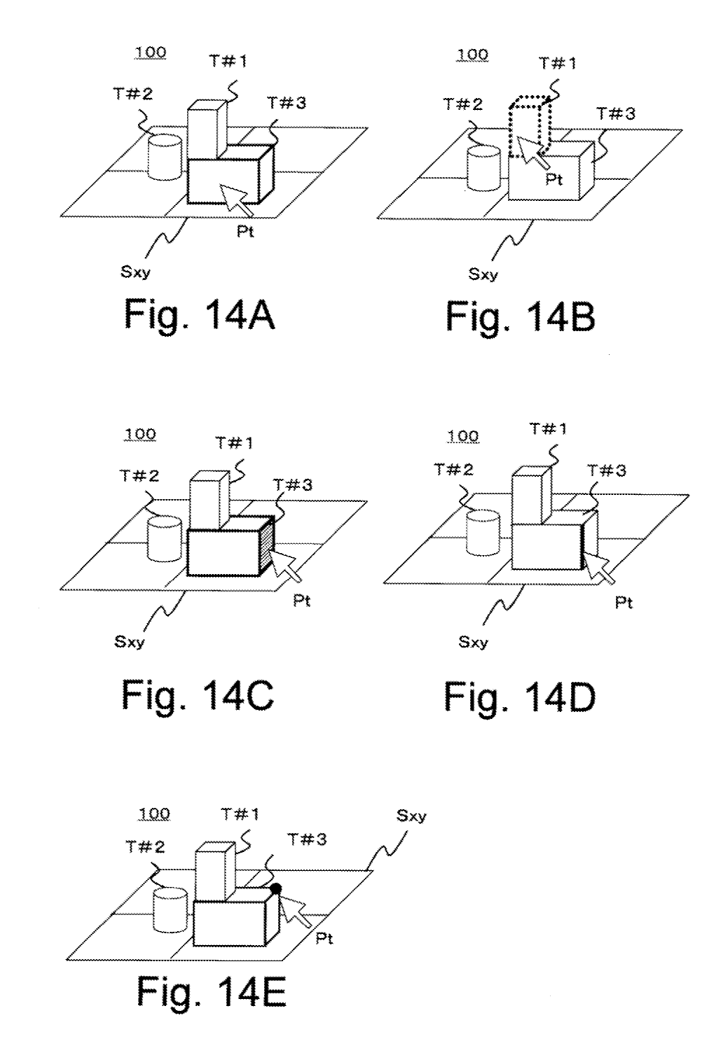

FIGS. 14A to 14E are diagrams illustrating examples of highlighting of structures.

FIGS. 14A to 14E illustrate a plurality of structures T#1 to T#3 arranged in a virtual space of the display screen 100.

In FIG. 14A, suppose the position of the input point Pt (current coordinates) is located in the region of the structure T#3. The highlighting processing section 22 highlights the entire outer surface or the entire boundary line of the structure T#3. In this case, the highlighting processing section 22 may perform highlighting using a display color or line type set for each item of physical property value information. When, for example, the material of the structure T#3 is “metal,” the highlighting processing section 22 displays the boundary line of the structure T#3 using a thick solid line associated with “metal.”

In FIG. 14B, suppose the position of the input point Pt is located in the region of the structure T#1. As in the case of the processing described in FIG. 14A, the highlighting processing section 22 highlights the structure T#1. When the material of the structure T#1 is “dielectric,” the highlighting processing section 22 can display the boundary line of the structure T#1 using a thick broken line associated with “dielectric.”

In FIG. 14C, suppose the position of the input point Pt is located on one boundary plane of the structure T#3. In this case, the highlighting processing section 22 displays the boundary plane on which the input point Pt is located in a deeper color than other boundary planes in addition to the display illustrated in FIG. 14A.

In FIG. 14D, suppose the position of the input point Pt is located on the boundary line (boundary edge) of the structure T#3. The highlighting processing section 22 displays the boundary line on which the input point Pt is located in a thicker solid line than the other boundary lines in addition to the display illustrated in FIG. 14A.

In FIG. 14E, suppose the position of the input point Pt is located on a vertex of the structure T#3. The highlighting processing section 22 further displays the vertex on which the input point is located with a black circle in addition to the display illustrated in FIG. 14A.

This makes it easier for the user to visually identify the boundary plane, boundary line, vertex or the like of the structure on the display screen 100 and allows the user to make a more efficient and accurate position setting of the input point Pt.

Step S82: Display Processing on Physical Property Value Information

The highlighting processing section 22 displays only a structure whose region is located at the coordinates of the input point in a display color set for each physical property with reference to physical property value information of the structure data. The display color based on the physical property value information is set, for example, to “yellow” when the material of the physical property value information is metal or “red” when the material of the physical property value information is a derivative.

The highlighting processing section 22 displays the outer surface of each structure displayed on the display screen 100 in a display color indicating physical properties based on the physical property value information of the structure data.

Furthermore, with reference to the structure data table 31, the highlighting processing section 22 displays only a structure having specific physical properties in a display color corresponding to the physical properties from among the structures displayed on the display screen 100.

Such ways of display processing allow the user to visually clearly distinguish a specific structure from other structures on the display screen 100. Furthermore, the user can easily discriminate the material of the structure (metal, dielectric or the like).

Furthermore, the physical property information display processing section 24 acquires physical property value information of a structure located at the position of the input point Pt or a structure selected by the user, generates a physical property value information display screen 155 that displays the acquired physical property value information and displays the acquired physical property value information on the monitor 2.

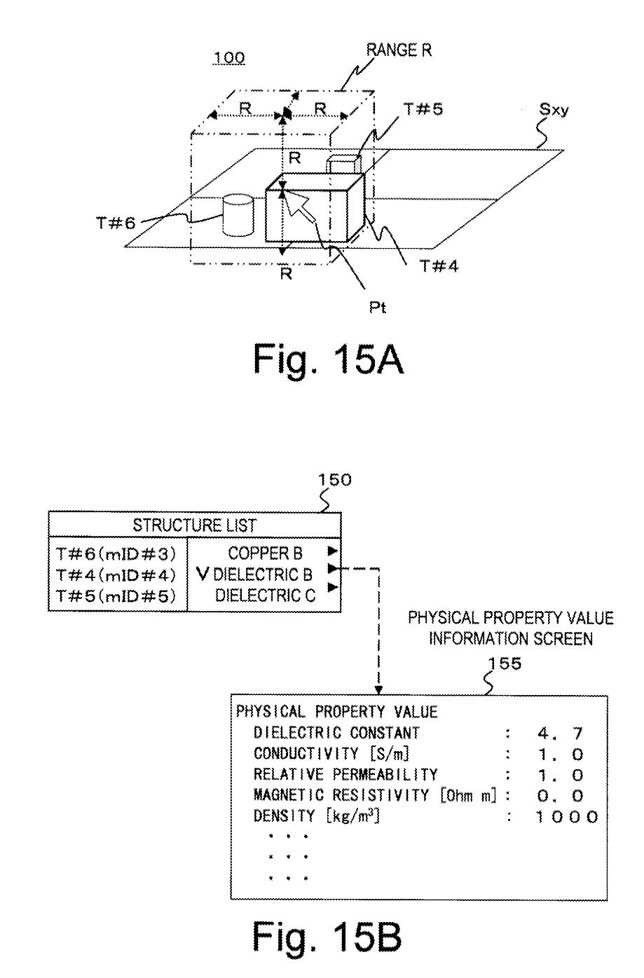

FIGS. 15A and 15B are diagrams illustrating display examples of the physical property value information.

As illustrated in FIG. 15A, suppose structures T#4 to T#6 located within a range R from an input point Pt of a virtual space are displayed on the display screen 100.

With reference to the structure data table 31, the physical property information display processing section 24 acquires physical property value information of structures T#3 to T#5 displayed on the display screen 100, generates a structure list screen 150 that displays the material name of each structure in a list form and displays the structure list screen 150 on the monitor 2.

Regarding the structure T#4 specified by the user on the structure list screen 150, the physical property information display processing section 24 displays a mark (v) indicating that the corresponding structure is selected on the structure list screen 150 as illustrated in FIG. 15B, generates a physical property value information screen 155 indicating more detailed physical property value information on the structure T#4 based on the physical property value information of the structure data table 31 and the physical property value information screen 155 displays, for example, physical property value information “dielectric constant: 4.7”, “conductivity (S/m): 1.0” on the monitor 2.

Step S83: Display Processing on Nearby Structure

When the display of a structure near the input point is selected by the user's specification, the structure analysis-setting section 21 identifies the structure located within a predetermined range R from the coordinates of the input point Pt based on the structure data table 31 and displays only the identified structure in a virtual space.

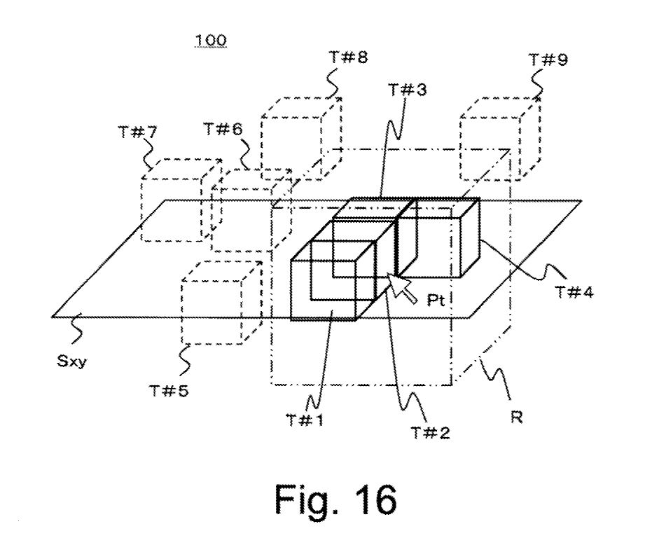

FIG. 16 is a diagram illustrating display processing on the nearby structure.

Suppose structures T#1 to T#9 illustrated in FIG. 16 are structures arranged in a virtual space displayed on the display screen 100.

The structure analysis-setting section 21 acquires the coordinates of an input point Pt and determines whether a predetermined reference position of each structure is located within a predetermined range R from the coordinates of the input point Pt with reference to the structure data table 31. Upon determining that the structures T#1 to T#4 are located within the range R and the structures T#5 to T#9 are located outside the range R, the structure analysis-setting section 21 displays only the structures T#1 to T#4 located within the range R in the virtual space of the display screen 100.

FIG. 16 illustrates the range R as a cubic region centered on the input point Pt, but the region of the range R may be set in any shape.

Step S84: First Guide Display Processing

When a display of a line of intersection indicating an association relationship between a sketch plane and a structure by the user's specification is selected, the first guide display processing section 25 displays a line of intersection gi between the sketch plane and the boundary plane of the structure on the display screen 100.

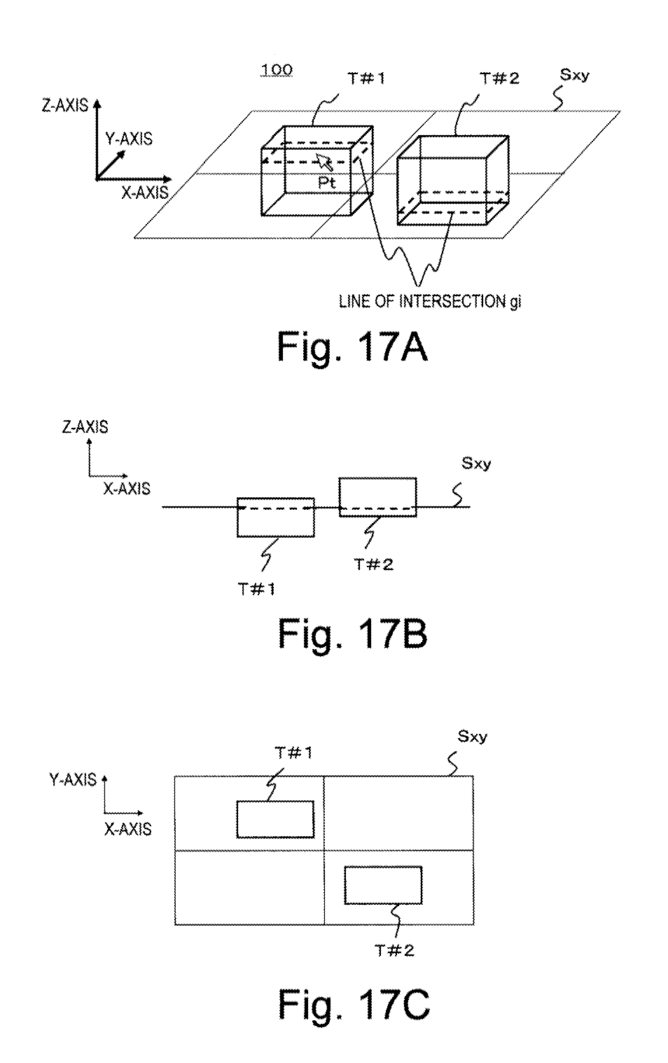

FIG. 17 is a diagram illustrating an example of display of the line of intersection between the sketch plane and the structure.

FIG. 17A is a diagram illustrating a relationship between a sketch plane Sxy and structures T#1 and T#2 in a perspective view. FIG. 17B is a side view which is an XZ plane indicating the sketch plane Sxy and structures T#1 and T#2 illustrated in FIG. 17A, and likewise FIG. 17C is a top view which is an XY plane.

The first guide display processing section 25 determines lines of intersection gi between the boundary planes and the sketch plane Sxy based on the structure data of the structures T#1 and T#2 and displays the lines of intersection gi between the structures T#1 and T#2 and the sketch plane Sxy displayed on the display screen 100 using, for example, broken lines.

This allows the user to easily recognize the arrangement of the structure on the display screen 100. For example, when the sketch plane Sxy and the lines of intersection (broken lines) gi illustrated in FIG. 17A are not displayed, it is difficult to visually recognize, in the positional relationship between the structure T#1 and structure T#2 displayed on the display screen 100, which structure is located higher (that is, more on the plus side in the Z-axis direction) or more backward (that is, more on the plus side in the Y-axis direction) in the virtual space. However, as illustrated in FIG. 17A, the user can easily grasp, through the display of the lines of intersection (broken lines) gi between the sketch plane Sxy and the structure, that the structures T#1 and T#2 have the positional relationship illustrated in FIG. 17B and FIG. 17C only from the perspective view illustrated in FIG. 17A.

Step S85: Second Guide Display Processing

When an instruction for displaying a guideline from an input point Pt is selected through the user's specification, the second guide display processing section 26 displays a guideline gl from the input point Pt to the boundary plane of a nearby structure on the display screen 100.

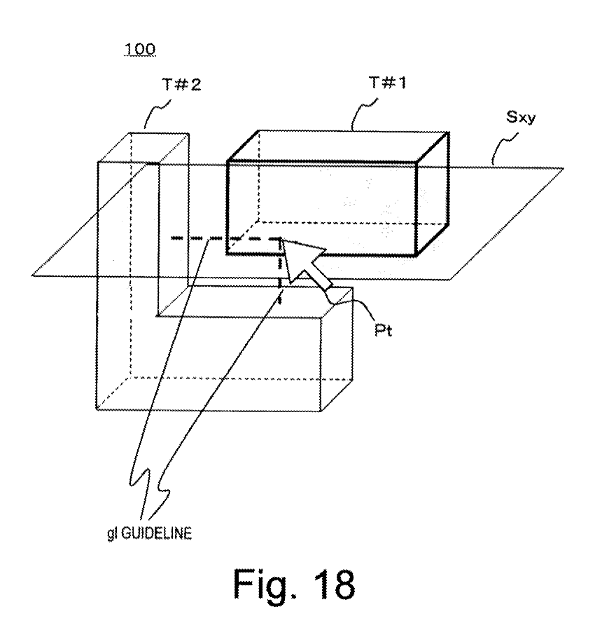

FIG. 18 is a diagram illustrating an example of display of the guideline gl from the input point Pt.

In a virtual space, suppose the input point Pt is located on the boundary plane of the bottom surface of a structure T#1 of a rectangular parallelepiped conductor and a structure T#2 of an L-shape conductor is located at the lower left of the structure T#1.

The second guide display processing section 26 sets straight lines which are parallel to each coordinate axis of the orthogonal coordinate system of the virtual space from the coordinates of the input point Pt and which are line segments up to the points of intersection with the boundary planes of the structure T#2 near the input point Pt as guidelines gl, and displays the set guidelines gl on the display screen 100.

As illustrated in FIG. 18, two guidelines gl (broken lines) from the position of the input point Pt to the boundary planes of the nearby structure T#2 are illustrated on the display screen 100.

This allows the user to easily grasp the positional relationship and a sense of approximate distance between the boundary planes of the structure T#2 and the boundary plane (bottom surface) of the structure T#1.

With such a first or second guideline display, the user can prevent such an arrangement error that the boundary plane of the structure T#1 is made to contact the boundary plane of the structure T#2 through visual illusion on the monitor 2.

Furthermore, since the positional relationship between the structure T#1 and structure T#2 can be grasped, a circuit element (e.g., capacitor) can be easily arranged between the structures.

Step S86: Virtual Space Rotation Display Processing

When a rotation display of the virtual space is selected through the user's specification, the rotation display processing section 28 generates a rotation coordinate system obtained by rotating a virtual space of a reference orthogonal coordinate system based on the rotation coordinate axis and angle of rotation by the user's specification and displays the virtual space of this rotation coordinate system on the display screen 100.

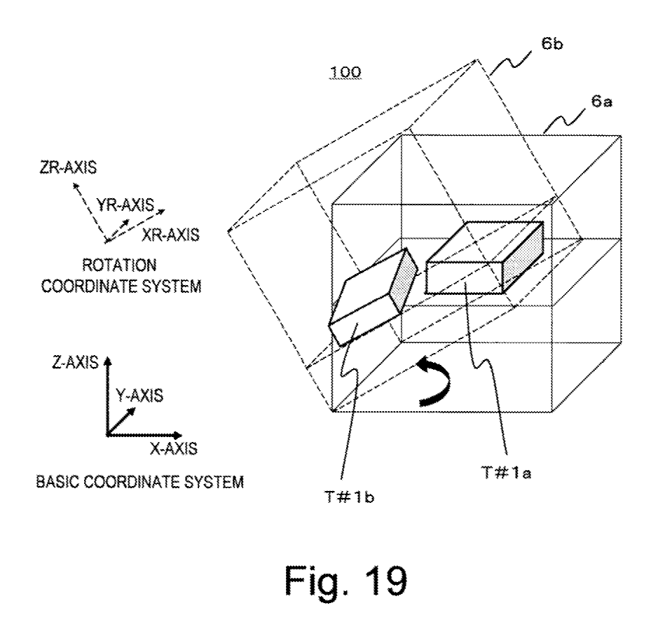

FIG. 19 is a diagram illustrating display processing on the rotation coordinate system.

The rotation display processing section 28 converts the whole of the virtual space of the basic orthogonal coordinate system (X-axis, Y-axis, Z-axis), set grid 6, arranged structure T#1a and input point Pt to a rotation coordinate system (XR-axis, YR-axis, ZR-axis) obtained through rotation by an arbitrary angle using a set coordinate axis as the axis of rotation based on the coordinate axis and an arbitrary angle selected by the user. The rotation display processing section 28 then displays the display screen 100 which displays a structure T#1b in a virtual space of the converted rotation coordinate system on the monitor 2. Furthermore, when a sketch plane is set in the original virtual space, the rotation display processing section 28 converts the orthogonal coordinate system also including the sketch plane to the rotation coordinate system and displays the rotation coordinate system with the sketch plane.

When the boundary plane of the structure located at an inclined position in a reference virtual space is set on the sketch plane, this display processing allows the user to correct the sketch plane inclined in the same way as the structure and display the sketch plane on the display screen 100 and the user can thereby perform operation in the virtual space in a condition in which the structure can be easily recognized.

Step S10: Data Creation and Saving Processing

While the user continues the input operation on the display screen 100 in the three-dimensional data display apparatus 10 (Yes in step S9), the processing in steps S4 to S8 is repeatedly performed. During that period, the structure information creating section 19 stores or updates structure data of a structure to be added or changed in the structure data table 31 of the data storage section 30 every time the user adds or changes a structure.

When the user ends the input operation (No in step S9), the data input-output processing section 11 saves the data stored in the structure data table 31 of the data storage section 30 in the structure information storage device 4 or another storage apparatus (not illustrated in FIG. 1) or various storage media or the like.

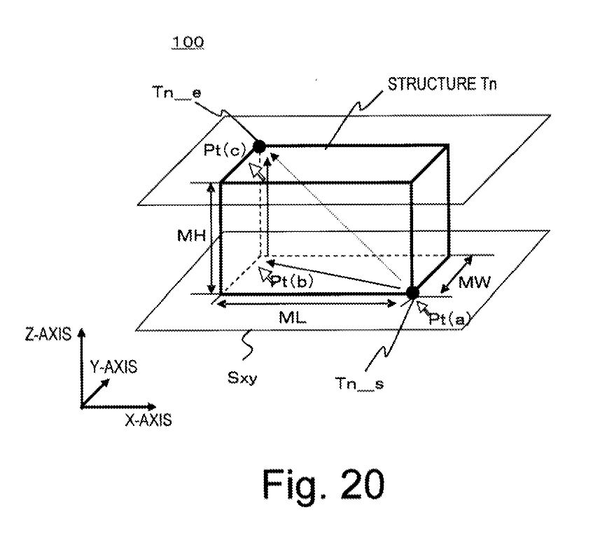

FIG. 20 is a diagram illustrating processing of creating structure data of a rectangular parallelepiped structure Tn.

Here, suppose the mouse 3 can perform two ways of moving operation; plane movement and wheel rotation, and performs the moving operation as illustrated in FIG. 13.

The operation information acquiring section 15 detects operation of the mouse 3 and acquires information such as first operation information, second operation information, left click or right click.

When creation of structure data is selected through right click operation of the mouse 3, the structure information creating section 19 displays, for example, a structure generation screen, acquires and stores the user's selection instruction for items necessary to create the structure data (e.g., items such as selection or non-selection of the structure, physical property value of the structure). The selection/non-selection of the structure is specification as to whether or not to use existing structure data.

Furthermore, upon acquiring the first operation information (plane movement) of the mouse 3, the structure information creating section 19 judges whether or not an input point Pt(a) specifies a start point (control point) of the structure. When the input point Pt(a) specifies the start point, the coordinates of the current input point Pt(a) are designated as a start point (control point) Tn_s. The structure information creating section 19 sets coordinates identified by a distance ML in the X-axis negative direction and a distance MW in the Y-axis positive direction on the sketch plane at the moving destination of the input point Pt from the moving direction and the amount of movement of the operation information and moves the input point Pt. The input point display processing section 23 displays the moved input point Pt(b).

Furthermore, upon acquiring second operation information from the mouse 3, the structure information creating section 19 designates the position identified by a distance MH from an input point Pt(b) in the Z-axis positive direction on the sketch plane as the moving destination of the input point Pt from the moving direction and the amount of movement of the operation information. The structure information creating section 19 then designates the coordinates of the moving destination as an end point (control point) Tn_e. The input point display processing section 23 displays a moved input point Pt(c).

For the rectangular parallelepiped structure Tn, the structure information creating section 19 sets the start point Tn_s(x1, y1, z1), end point Tn_e(x2, y2, z2) and generates structure information with length ML=|x1−x2|, width MW=|y1−y2|, height MH=|z1−z2|.

Next, the structure information creating section 19 displays a predetermined physical property value input screen on the monitor 2. Here, when selection of the structure is set on the structure generation screen, the structure information creating section 19 displays the physical property value information of the selected structure as an initial value of the physical property value input screen.

Upon acquiring the value of each item of the physical property value information through the user's input operation on the structure generation screen, the structure information creating section 19 adds the physical property value information of the structure Tn to the structure data and stores the structure data (including the structure information and the physical property value information) in the structure data table 31.

Although the rectangular parallelepiped structure has been used as an example of the structure data creation processing, the structure information creating section 19 can create a model of any shape.

Hereinafter, some of processing steps making up a processing flow of the three-dimensional data display apparatus 10 illustrated in FIG. 4 and FIG. 5 will be described in more detail.

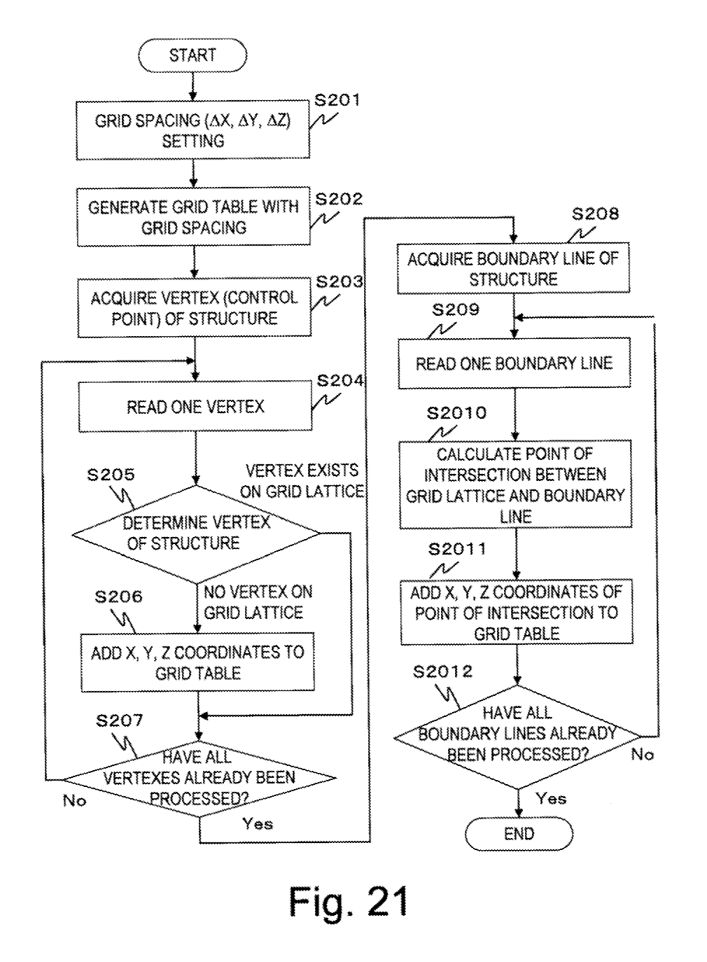

FIG. 21 is a more detailed processing flowchart of the grid setting processing (FIG. 4: step S2).

The grid spacing setting section 18 displays the grid spacing setting screen 120 on the monitor 2, receives the input setting by the user and sets grid spacing (ΔX, ΔY, ΔZ) (step S201).

The grid setting-updating section 13 sets the grid 6 in the virtual space based on the set grid spacing and generates the grid table 32 that stores the coordinates gc in the virtual space of each grid lattice g of the grid 6 (step S202). With reference to the structure data table 31, the grid setting-updating section 13 acquires vertexes (control points) of the structure from the structure data of all structures (step S203).

Next, the grid setting-updating section 13 reads one of the acquired vertexes (step S204) and determines whether or not the vertex of the read structure is on the grid lattice, that is, whether or not the coordinates of the vertex match the coordinates gc stored in the grid table 32 (step S205). The grid setting-updating section 13 adds the coordinates of the vertex to the grid table 32 as the coordinates mc of the auxiliary grid lattice m only when the vertex is not found on the grid lattice g (step S206). When all vertexes have not been processed (No in step S207), the grid setting-updating section 13 returns to the processing in step S204 or when all vertexes have been processed (Yes in step S207), the grid setting-updating section 13 moves to next step 208.

Next, with reference to the structure data table 31, the grid setting-updating section 13 acquires a boundary line of the structure from the structure data of all the structures (step S208). Upon reading one boundary line (step S209), the grid setting-updating section 13 calculates a point of intersection between the grid lattice of the grid table 32 and the read boundary line (step S2010).

When the calculated coordinates of the point of intersection are not found in the coordinates gc and mc stored in the grid table 32, the grid setting-updating section 13 adds the coordinates of the point of intersection to the grid table 32 as coordinates nc of an auxiliary grid lattice n (step S2011).

When the entire boundary line has not been processed (No in step S2012), the grid setting-updating section 13 returns to the processing in step S209 or ends the processing when the entire boundary line has been processed (Yes in step S2012).

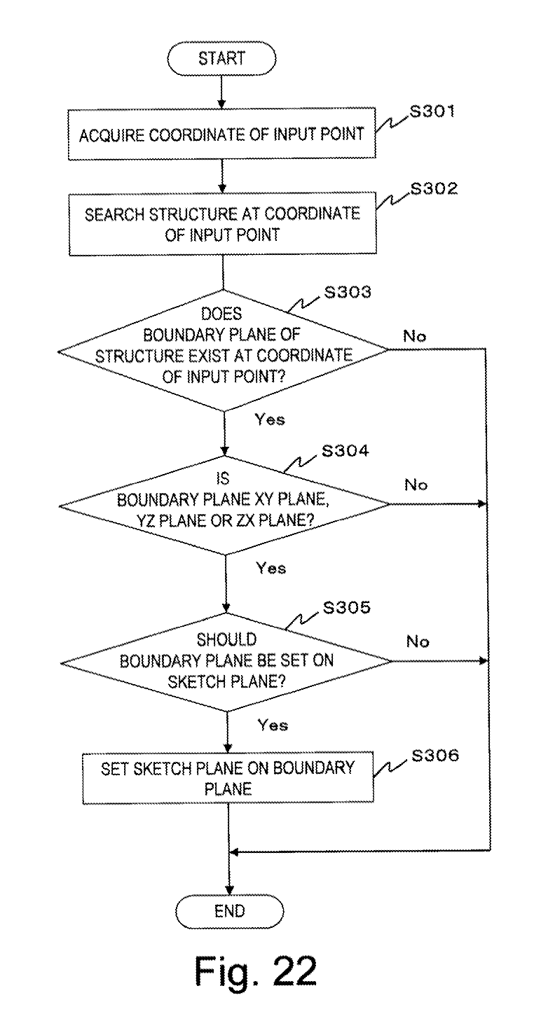

FIG. 22 is a more detailed processing flowchart of the sketch plane setting processing on the boundary plane of the structure, which is one of the sketch plane setting processing (FIG. 4: step S3).

The sketch plane setting section 14 acquires the current coordinates of the input point Pt from the input point position calculation section 16 (step S301) and searches a structure that includes the coordinates of the input point Pt in the region thereof with reference to the structure data table 31 (step S302). Furthermore, the sketch plane setting section 14 determines whether or not the coordinates of the input point Pt are located on the boundary plane of the specified structure (step S303). Only when the coordinates of the input point Pt are located on the boundary plane (Yes in step S303), the process is moved to next step S304.

The sketch plane setting section 14 determines whether the boundary plane where the input point Pt is located is the XY plane, YZ plane or ZX plane (step S304). Only upon determining that the boundary plane is any one of the XY plane, YZ plane and ZX plane (Yes in step S304), the sketch plane setting section 14 moves the processing to the next processing in step S305.

When the boundary plane is set on the sketch plane through the user's input instruction (Yes in step S305), the sketch plane setting section 14 sets the plane of the boundary plane including the coordinates of the input point Pt on the sketch plane (step S306).

On the other hand, when the coordinates of the input point Pt are not located on the boundary plane of the structure (No in step S303), and when the boundary plane is none of the XY plane, YZ plane or ZX plane, but the user's arbitrary plane (No in step S304), and there is no setting of the sketch plane by the user's input specification (No in step S305), the sketch plane setting section 14 does not perform the processing in step S306 and ends the processing.

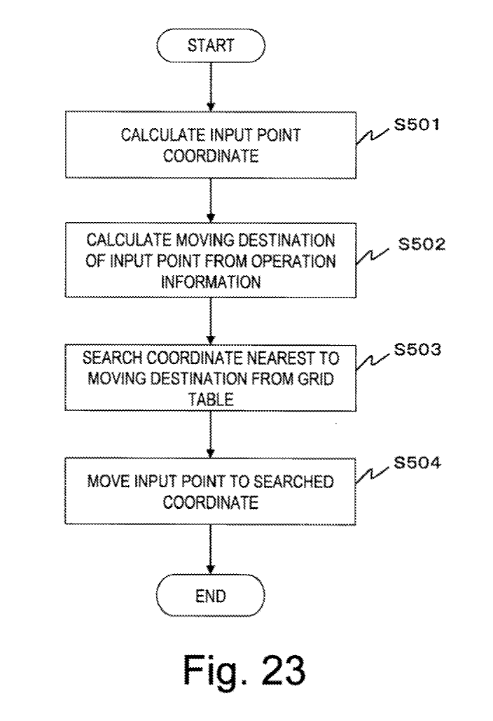

FIG. 23 is a more detailed processing flowchart of the input point Pt moving processing according to the grid table which is one of input point Pt moving processing (FIG. 4: step S5).

The input point position calculation section 16 calculates the current coordinates of the input point Pt of the virtual space (step S501). The input point position calculation section 16 then calculates the coordinates of the moving destination of the input point Pt from the moving direction and the moving distance included in the operation information acquired from the operation information acquiring section 15 (step S502) and searches coordinates nearest to the coordinates of the moving destination of the input point Pt with reference to the grid table 32 (step S503). The input point position calculation section 16 sets the searched coordinates as the coordinates of the input point Pt and moves the input point Pt (step S504).

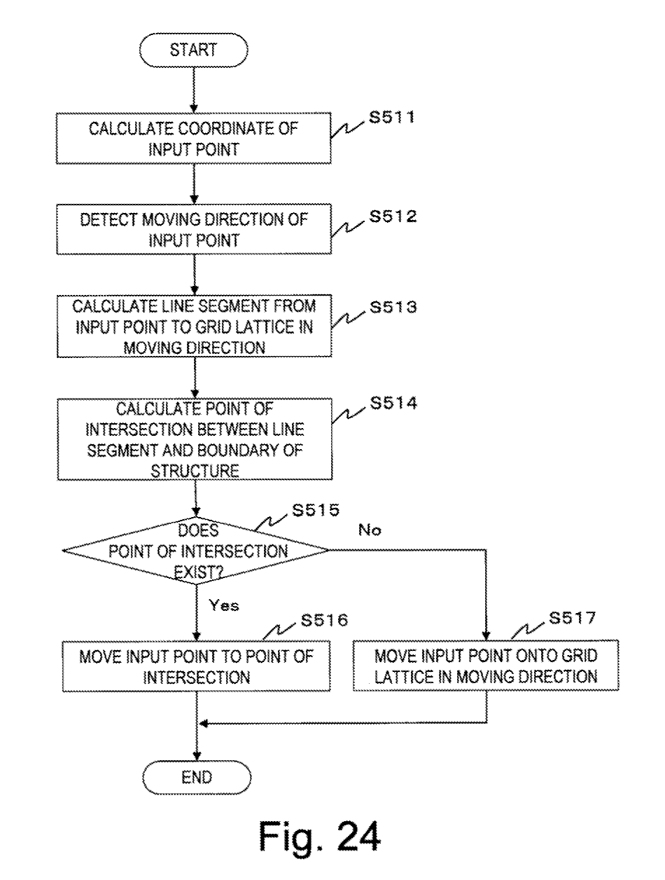

FIG. 24 is a more detailed processing flowchart of the input point Pt moving processing according to moving tracks, which is one of the input point Pt moving processing (FIG. 4: step S5).

The input point position calculation section 16 calculates the current coordinates of the input point Pt of the virtual space (step S511). The input point position calculation section 16 detects the moving direction included in the operation information acquired from the operation information acquiring section 15 (step S512) and calculates a line segment (moving track) up to the grid lattice in the moving direction detected from the input point Pt (step S513).

Furthermore, with reference to the structure data table 31, the input point position calculation section 16 calculates a point of intersection between the calculated line segment and the boundary of the structure (step S514). As a result, when there is a point of intersection between the line segment and the boundary of the structure (Yes in step S515), the input point position calculation section 16 designates the point of intersection between the calculated line segment and the boundary of the structure as the moving destination of the input point Pt, sets the coordinates of the point of intersection as the coordinates of the input point Pt and moves the input point P (step S516). When there is no point of intersection between the line segment and the boundary of the structure (No in step S515), the input point position calculation section 16 designates the grid lattice g in the moving direction as the moving destination of the input point Pt, sets the coordinates of the grid lattice g as the coordinates of the input point Pt and moves the input point P (step S517).

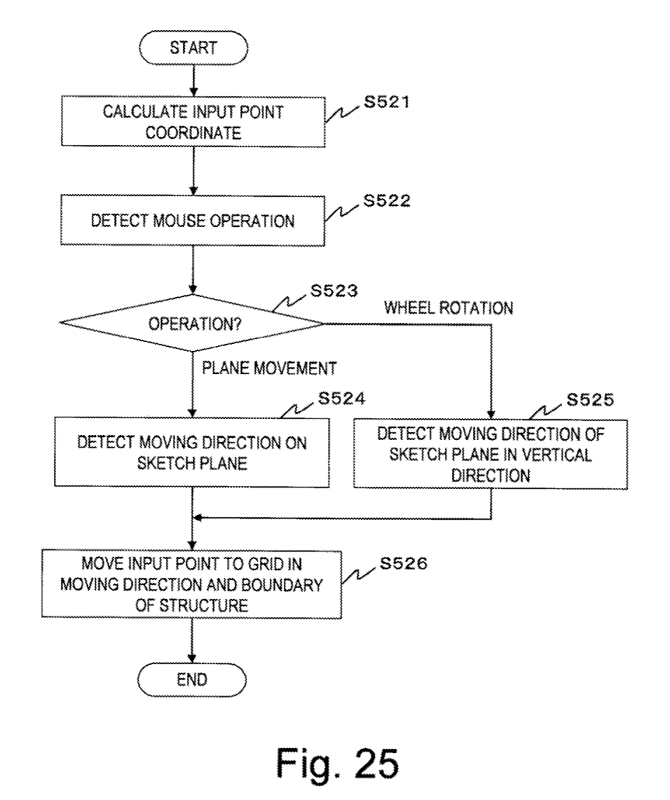

FIG. 25 is a more detailed processing flowchart of the moving processing on the input point Pt using the mouse 3 which allows two ways of moving operation to be inputted, which is one of the input point Pt moving processing (FIG. 4: step S5).

Suppose the sketch plane is set by the sketch plane setting section 14 before starting this processing, the moving direction of plane movement of the mouse 3 is associated with the coordinate axes (X-axis, Y-axis) on the sketch plane (e.g. sketch plane Sxy) and the moving direction by wheel rotation is associated with the coordinate axis (Z-axis) corresponding to the vertical direction of the sketch plane.

The input point position calculation section 16 calculates the current coordinates of the input point Pt of the virtual space (step S521). The input point position calculation section 16 detects operation information on the mouse 3 from the operation information acquiring section 15 (step S522) and determines, from the operation information, whether the operation of the mouse 3 is plane movement or wheel rotation (step S523). When the operation of the mouse 3 is plane movement, the input point position calculation section 16 detects the moving direction on the sketch plane from the operation information (step S524). When the operation of the mouse 3 is wheel rotation, the input point position calculation section 16 detects the moving direction of the sketch plane in the vertical direction from the operation information (step S525).

The input point position calculation section 16 then designates the point of intersection between the grid lattice g in the detected moving direction or the grid 6 and the boundary of the structure as the moving destination of the input point Pt, sets the coordinates of the moving destination as the coordinates of the input point Pt and moves the input point Pt (step S526).

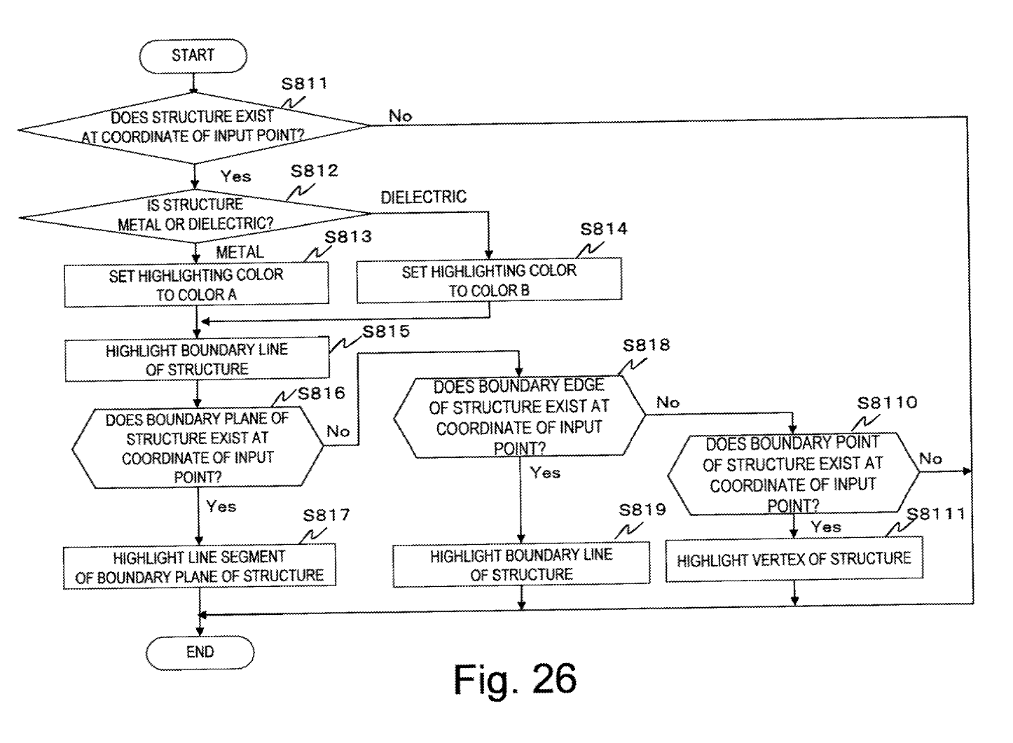

FIG. 26 is a more detailed processing flowchart of the highlighting processing (FIG. 5: step S81).

With reference to the composition data table 31, the highlighting processing section 22 determines whether or not a structure exists at the coordinates of the input point Pt (step S811). When a structure exists at the coordinates of the input point Pt (Yes in step S811), the highlighting processing section 22 determines, with reference to the structure data table 31, whether the material of the physical property value information of the corresponding structure is metal or dielectric (step S812). When the material of the physical property value information of the structure is metal, the highlighting processing section 22 sets the highlighting color of the structure as color A (step S813). On the other hand, when the material of the physical property value information of the structure is dielectric, the highlighting processing section 22 sets the highlighting color of the structure as color B (step S814). Furthermore, the highlighting processing section 22 highlights the boundary line of the structure with a predetermined line (step S815).

Next, the highlighting processing section 22 determines whether or not the boundary plane of the structure exists at the coordinates of the input point Pt (step S816). When the boundary plane of the structure exists at the coordinates of the input point Pt (Yes in step S816), the highlighting processing section 22 highlights the line segment of the boundary plane of the structure (step S817). On the other hand, when no boundary plane of the structure exists at the coordinates of the input point Pt (No in step S816), the highlighting processing section 22 moves to the next processing in step S818.

The highlighting processing section 22 determines whether or not a boundary edge of the structure (boundary line contacting two boundary planes) exists at the coordinates of the input point Pt (step S818). When a boundary edge of the structure exists at the coordinates of the input point Pt (Yes in step S818), the highlighting processing section 22 highlights the boundary line of the structure (step S819). On the other hand, when no boundary edge of the structure exists at the coordinates of the input point Pt (No in step S818), the highlighting processing section 22 moves to the processing in step S8110.

The highlighting processing section 22 determines whether or not a boundary point (vertex) of the structure exists at the coordinates of the input point Pt (step S8110). When a boundary point of the structure exists at the coordinates of the input point Pt (Yes in step S8110), the highlighting processing section 22 highlights the vertex of the structure (step S8111).

When no boundary point of the structure exists at the coordinates of the input point Pt in the processing in step S8110 (No in step S8110), the highlighting processing section 22 ends the processing. That is, the highlighting processing on the structure is not performed.

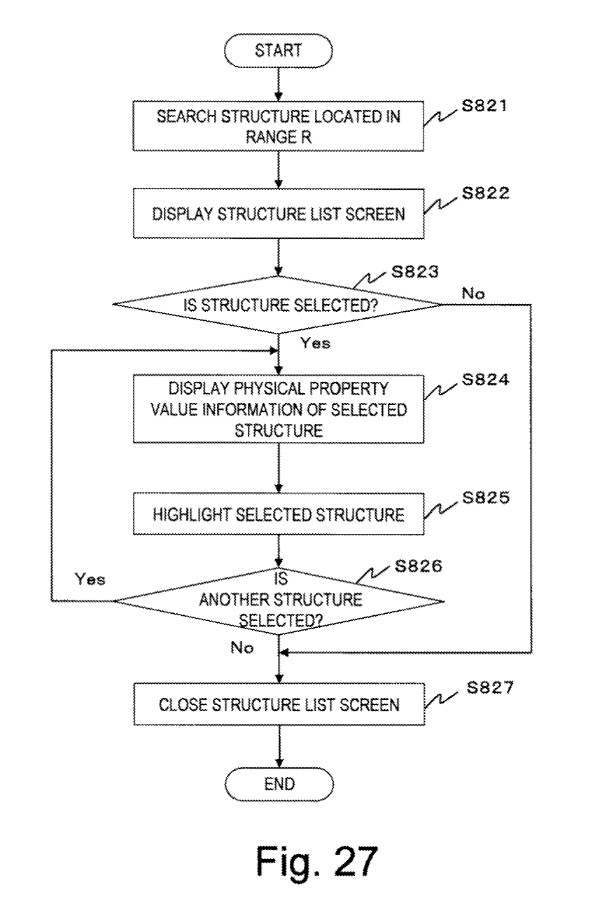

FIG. 27 is a more detailed processing flowchart of the physical property value information display processing (FIG. 5: step S82).

With reference to the structure data table 31, the structure analysis-setting section 21 searches a structure that exists within the range R from the coordinates of the input point Pt (step S821). The physical property information display processing section 24 generates the structure list screen 150 indicating a list of names and materials of structures based on the physical property value information of the searched structures and displays the structure list screen 150 on the monitor 2 (step S822).

Upon detecting a selection of a structure on the structure list screen 150 from the operation information acquired by the operation information acquiring section 15 (Yes in step S823), the physical property information display processing section 24 generates the physical property value information screen 155 that displays the physical property value information of the selected structure and displays the physical property value information screen 155 on the monitor 2 (step S824). Furthermore, the highlighting processing section 22 highlights the boundary of the selected structure (step S825).

When the physical property information display processing section 24 determines that a selection of another structure has been detected on the structure list screen 150 from the operation information acquired by the operation information acquiring section 15 (Yes in step S826), the physical property information display processing section 24 returns to the processing in step S824.

On the other hand, upon determining that a selection of another structure has not been detected on the structure list screen 150 (No in steps S823 and S826), the physical property information display processing section 24 closes the structure list screen 150 and physical property value screen 155 (step S827) and ends the processing.

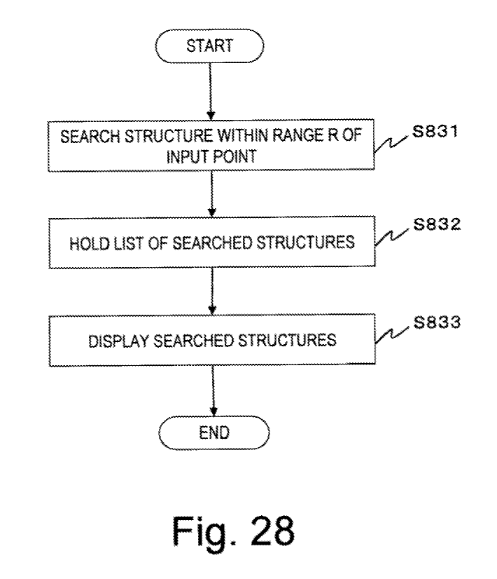

FIG. 28 is a more detailed processing flowchart of the nearby structure display processing (FIG. 5: step S83).

With reference to structure data table 31, the structure analysis-setting section 21 searches structures existing within the range R from the coordinates of the input point Pt (step S831) and stores a list of structures existing within the searched range R (step S832). The structure analysis-setting section 21 arranges the structures in the virtual space based on the list of structures stored and displays the structures on the display screen 100 (step S833).

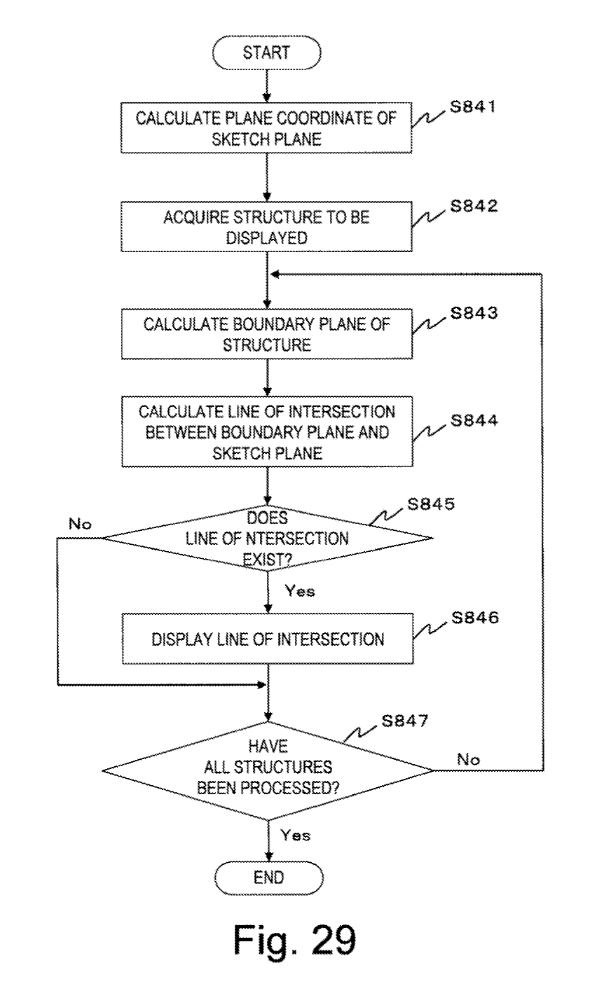

FIG. 29 is a more detailed processing flowchart of the display processing (FIG. 5: step S84) of the line of intersection between the sketch plane and the structure.

The first guide display processing section 25 calculates plane coordinates of the set ketch plane (step S841). Furthermore, with reference to the structure data table 31, the first guide display processing section 25 acquires the structure at the position where sketch planes overlap with each other (step S842) and calculates the boundary plane of the acquired structure (step S843).

The first guide display processing section 25 then calculates a line of intersection between the boundary plane of the structure and the sketch plane (step S844). When the calculation result shows that the line of intersection exists (Yes in step S845), the first guide display processing section 25 displays the line of intersection on the display screen 100 (step S846). On the other hand, when no line of intersection exists (No in step S845), the first guide display processing section 25 moves to the processing in step S847.

When none of the structures detected in step S842 has been processed (No in step S847), the first guide display processing section 25 returns to the processing in step S843, whereas when the structures have been processed (Yes in step S847), the first guide display processing section 25 ends the processing.

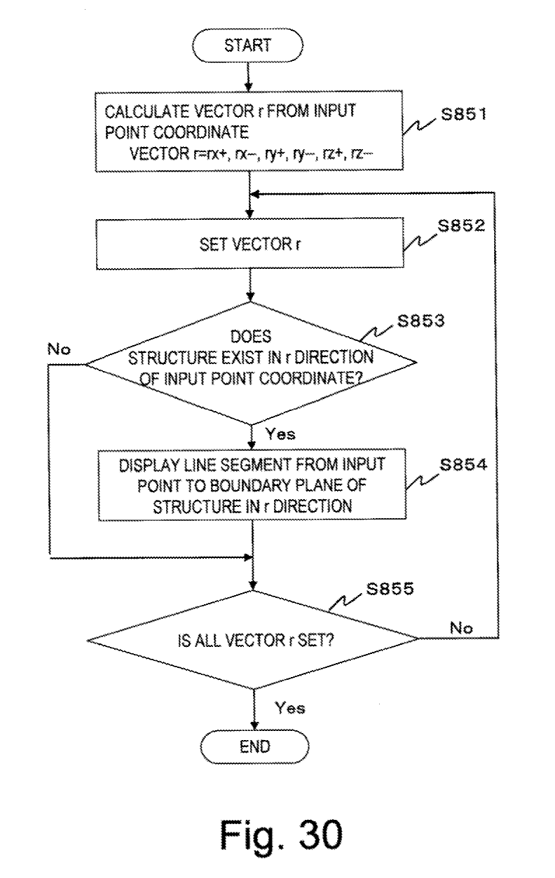

FIG. 30 is a more detailed processing flowchart of the guideline display processing (FIG. 5: step S85). Here, suppose the coordinates of the input point Pt are located on a certain boundary plane of the structure.

The second guide display processing section 26 calculates a vector r{rx+, rx−, ry+, ry−, rz+, rz−} from the coordinates of the input point Pt (step S851). Next, the second guide display processing section 26 sets a vector r=rx+ (step S852) and determines whether or not another structure exists in the direction of the vector rx+ from the coordinates of the input point Pt with reference to the structure data table 31 (step S853). When another structure exists in the direction of the vector rx+ (Yes in step S853), the second guide display processing section 26 calculates a line segment from the input point Pt to the boundary plane of the other existing structure and displays the calculated line segment on the display screen 100 as a guideline (step S854). When the entire vector r is not set (No in step S855), the second guide display processing section 26 returns to the processing in step S852 or ends the processing when the entire vector r is set (Yes in step S855).

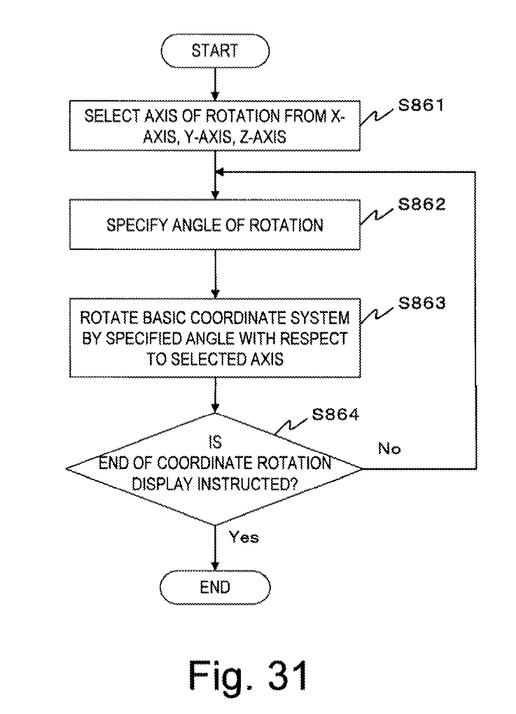

FIG. 31 is a more detailed processing flowchart of the rotation display processing on the coordinate system (FIG. 5: step S86).

The rotation display processing section 28 selects an axis of rotation from the X-axis, Y-axis and Z-axis of the virtual space based on the user's instruction input (step S861) and further sets an angle of rotation (step S862). Next, the rotation display processing section 28 rotates the coordinate system of the virtual space by a specified angle with respect to the set axis of rotation based on the set axis of rotation and angle of rotation, and thereby converts the coordinate system to a rotation coordinate system (step S863).

The rotation display processing section 28 then determines whether or not there is an input of an instruction for ending the coordinate system rotation (step S864), returns to the processing in step S862 when there is no input of an instruction for ending the coordinate system rotation (No in step S864) or ends the processing when there is an input of an instruction for ending the coordinate system rotation (Yes in step S864).

Hereinafter the structure data generation processing by the three-dimensional data display apparatus 10 will be described.

When the user moves the pointer Pt on the display screen 100 displayed on the monitor 2 and creates or changes a structure in the virtual space, the structure information creating section 19 creates or changes structure data of the corresponding structure.

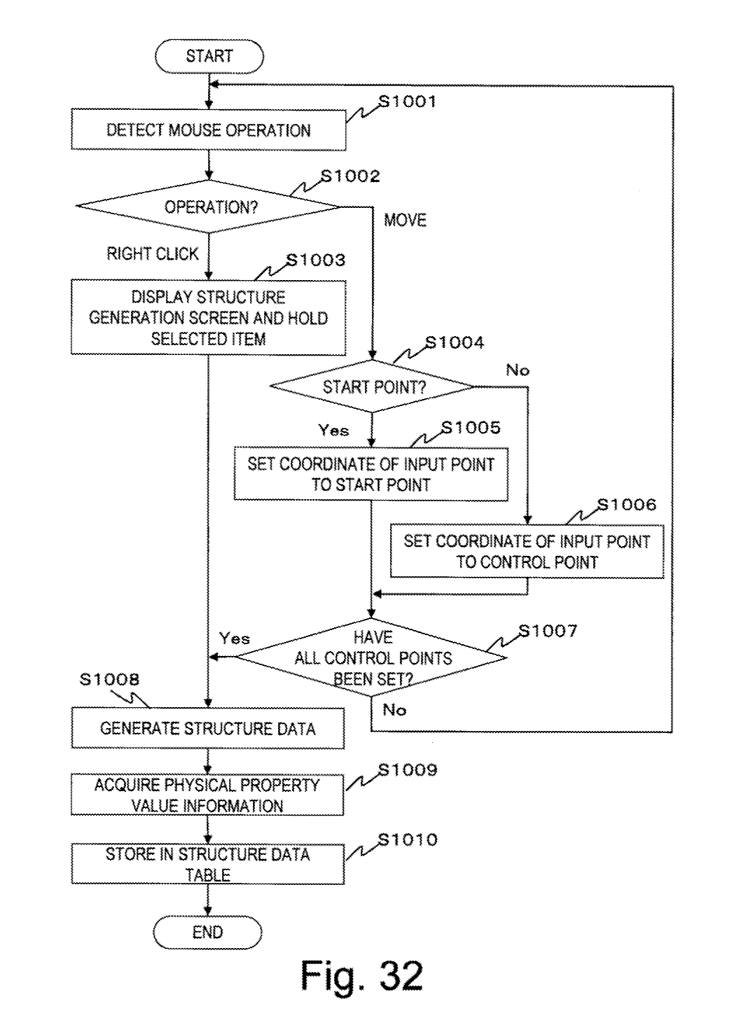

FIG. 32 is a processing flowchart of structure information creation processing.

This structure information creation processing is started by the user inputting an instruction.

The operation information acquiring section 15 detects operation of the mouse 3 and detects the operation information (step S1001).

The structure information creating section 19 determines from the operation information whether or not the operation of the mouse 3 is a right click (step S1002) and displays, when the operation of the mouse 3 is a right click, a structure generation screen on the monitor 2 (step S1003). The structure information creating section 19 stores a selected item such as selection or non-selection of the structure and a physical property value of the structure on the structure generation screen (step S1003).

When the operation of the mouse 3 is a moving operation, the structure information creating section 19 determines whether or not the input point Pt is set as a start point (control point) (step S1004), and sets, when the input point Pt is set as a start point (Yes in step S1004), the coordinates of the input point Pt as a start point (control point) (step S1005). When the input point Pt is set as a control point other than a start point, the structure information creating section 19 sets the coordinates of the input point Pt as the next control point (step S1006).

The structure information creating section 19 determines whether or not necessary control points of the structure have been set (step S1007) and generates, when all the necessary control points have been set (Yes in step S1007), structure information of the structure data based on the set control points (step S1008). The structure information creating section 19 further displays the physical property value input screen 210 on the monitor 2, acquires the value of each item of the physical property value information through the user's input operation (step S1009) and stores structure information and structure data including the physical property value information in the structure data table 31 (step S1010).

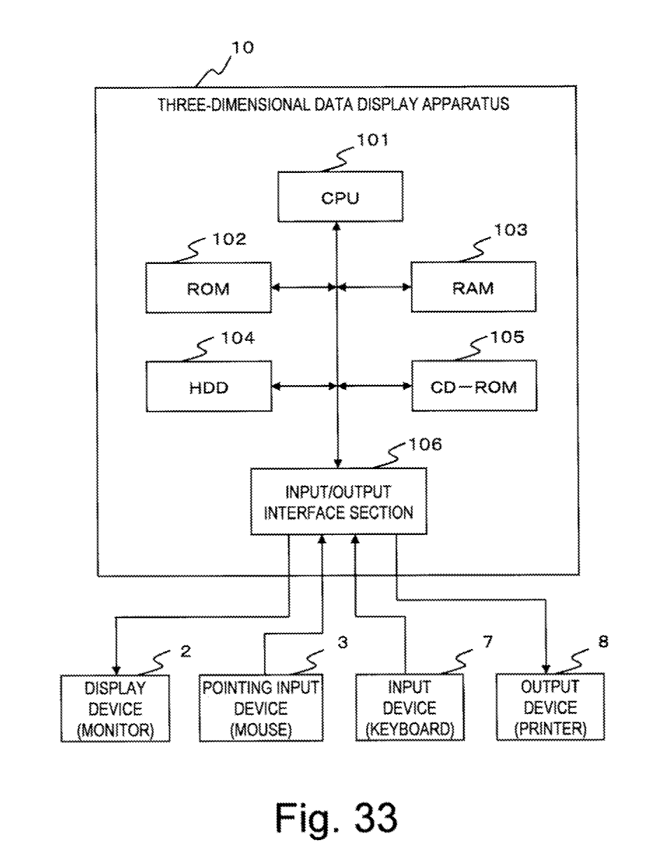

FIG. 33 is a diagram illustrating an example of hardware configuration according to the embodiment of the present invention of the three-dimensional data display system 1 illustrated in FIG. 1.

As illustrated in FIG. 33, the three-dimensional data display system 1 may be provided with the three-dimensional data display apparatus 10, the display device (monitor) 2, the pointing input device (mouse) 3, an input device (keyboard) 7 and an output device (printer) 8.

The three-dimensional data display apparatus 10 is provided with a CPU (Central Processing Unit) 101, a ROM (Read Only Memory) 102, a RAM (Random Access Memory) 103, an HDD (Hard Disk Drive) 104, a CD-ROM 105 and an input/output interface section 106.

The monitor 2 illustrated in FIG. 33 is the display device 2 illustrated in FIG. 1 and likewise, the mouse 3 is the pointing input device 3 illustrated in FIG. 1. Though not illustrated in FIG. 1, the three-dimensional data display apparatus 10 can be naturally provided with the keyboard 7 as another input device and the printer 8 as another output apparatus or the like.

The CPU 101 of the three-dimensional data display apparatus 10 starts boot processing based on a starting program stored in the ROM 102 at startup such as after power-up of the three-dimensional data display apparatus 10. The ROM 102 is a memory that stores a starting program of the CPU 101.

The CPU 101 reads an application program (application) of the three-dimensional data display apparatus 10 from the HDD 104 or CD-ROM 105 after startup and stores the read application in the RAM 103. The RAM 103 is a main memory (storage apparatus) of the CPU 101 and is used as a work area or the like when the CPU 101 executes an application in addition to the main memory. The application is a program for operating the CPU 101 and RAM 103 or the like as the three-dimensional data display apparatus 10. The RAM 103 corresponds to the data storage section 30 illustrated in FIG. 1.

The CPU 101 and RAM 103 or the like execute processing by the respective processing sections illustrated in FIG. 1 according to the application. The application installed in and executed by the computer causes the processing of the respective processing sections of the three-dimensional data display apparatus 10 illustrated in FIG. 1 to be realized and operates, by cooperating with hardware provided for the computer, as the three-dimensional data display apparatus 10.

The HDD 104 is a hard disk apparatus and is provided with, for example, the structure data storage device 4 illustrated in FIG. 1 and can also store other data. The HDD 104 may also be a database provided for a server or other storage apparatus or the like or may also have a configuration in which the three-dimensional data display apparatus 10 accesses the structure information storage device 4 via a network.

The CD-ROM 105 is a drive apparatus for reading applications and various kinds of data or the like recorded in a CD-ROM medium. The CD-ROM 105 may also be a drive apparatus for reading another recording medium such as a DVD (Digital Versatile Disk), FD (Floppy Disk, registered trademark).

After the application of the three-dimensional data display apparatus 10 starts, the user executes input operation such as input and arrangement of structures, selection, specification or the like using a screen via the mouse 3 and the keyboard 7 while viewing the monitor 2. In the three-dimensional data display apparatus 10, the CPU 101 executes a control instruction according to the input operation from the user and causes the monitor 2 to display not only the display screen 100 on which a structure arranged in a virtual space is displayed based on data stored in the RAM 103 but also display data such as a physical property value information display screen on which a physical property value information on the structure or the like is displayed.

The three-dimensional data display apparatus 10 as one embodiment of the present invention can store an application program in the HDD 104 beforehand. Furthermore, the program may be recorded in a CD-ROM medium and the three-dimensional data display apparatus 10 can also store the program from the CD-ROM medium in the RAM 103, HDD 104 or the like. That is, the computer (CPU 101, ROM 102 or the like) can operate as the three-dimensional data display apparatus 10 according to an application program installed in the CD-ROM medium. Other recording media may also be used instead of the CR-ROM medium.

As described so far, the three-dimensional data display apparatus 10 according to the present embodiment can precisely and efficiently specify the input point Pt at a position on a grid lattice set in a three-dimensional space or on a boundary of an arranged structure on the display screen 100 displayed on the monitor 2. When the user performs operation of setting the structure or end point in the three-dimensional virtual space, this allows the user to improve operability, reduce setting errors and drastically shorten the operation time such as generation and updating of structure data. It is also possible to reduce waste in a processing time of analysis processing caused by setting errors.

To be more specific, as a premise to realize an accurate analysis using a three-dimensional electromagnetic field simulator, structure data for an analysis is required in which metal interference among structures and handling of end points left open or the like are accurately set. However, there have been cases where it is difficult to select a target structure from among many structures on the two-dimensional plane (display screen 100) where three-dimensional structures are expressed overlapping with each other.

The disclosed three-dimensional data display apparatus 10 can judge physical properties (whether it is a metal or dielectric) of a structure specified by an input point Pt and display the structure highlighted according to the physical properties. Furthermore, since physical property value information on the structure can be displayed, the user can immediately judge whether or not the structure at the input point Pt is a target structure.

Furthermore, the three-dimensional data display apparatus 10 is provided with a function of displaying only structures in the vicinity of the input point Pt, a guideline function of displaying a guideline (line segment) in the X-axis, Y-axis and Z-axis directions up to a structure in the vicinity of the input point Pt, a display function such as a function of displaying a line of intersection between a sketch plane and the surface of the structure. This allows the user to easily and reliably select a target structure from among many structures.

Moreover, conventionally, the input point Pt in the virtual space moves on the plane which is a projected virtual space in conjunction with the position of the input point Pt on the display screen 100 that moves according to plane movement of the mouse 3. However, since there is no information in the depth direction, the coordinate values need to be inputted to move the input point Pt to an arbitrary position in the virtual space.

According to the disclosed three-dimensional data display apparatus 10, the moving means of the input point Pt can also limit the moving direction of the input point Pt within the virtual space by plane movement of the mouse 3 that allows two ways of moving operation to the moving direction on the plane set as the sketch plane in the virtual space, further limit the moving direction of the input point Pt by wheel rotation of the mouse 3 to the moving direction in the direction perpendicular to the sketch plane, link the movement by operation of the mouse 3 with movement of the input point Pt and thereby improve operability of movement of the input point Pt.

Thus, the disclosed three-dimensional data display apparatus 10 can easily and reliably make an exact position setting of the input point Pt in the virtual space, for example, a setting of a circuit element between conductors, improve operability in the structure data creation operation for a three-dimensional electromagnetic field simulator and support efficient generation of error-free structure data.

All examples and conditional language recited herein are intended for pedagogical purposes to aid the reader in understanding the invention and the concepts contributed by the inventor to furthering the art, and to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A three-dimensional data display apparatus provided with a display device and a pointing input device for causing the display device to display a structure to be processed in a virtual space, comprising:
a structure information storage section that stores structure information including structure information indicating a shape and arrangement of the structure and physical property value information indicating a material and a predetermined physical property value;
a screen display processing section that generates a display screen with a structure arranged in a virtual space of a three-dimensional orthogonal coordinate system based on the structure information and displays the generated display screen on the display device;
a grid setting section that sets a grid in the virtual space based on predetermined grid spacing;
an operation information acquiring section that acquires operation information indicating a moving direction and an amount of movement of the input point from the pointing input device;
an input point position calculation section that calculates coordinates in the virtual space of the input point, calculates a moving destination of the input point based on the operation information, selects any one of coordinates of each grid lattice based on the set grid, coordinates of a boundary of the structure and coordinates of an intersection between the boundary of the structure and the grid as coordinates at a minimum distance from the moving destination and updates the coordinates of the input point with the selected coordinates; and
an input point display processing section that displays, when the coordinates of the input point are updated, the input point at a position indicating the updated coordinates of the input point in the virtual space.

2. The three-dimensional data display apparatus according to claim 1, wherein the screen display processing section sets a display color indicating a material of the structure beforehand, displays the structure arranged in the virtual space based on the structure information color-coded in the display color.

3. The three-dimensional data display apparatus according to claim 1, wherein the screen display processing section displays only a structure having specific physical properties out of the structures arranged in the virtual space on the display screen based on the structure information.

4. The three-dimensional data display apparatus according to claim 1, wherein the screen display processing section displays only a structure located within a predetermined distance from the coordinates of the input point in the virtual space on the display screen based on the structure information.

5. The three-dimensional data display apparatus according to claim 1, wherein the screen display processing section identifies a structure to be located at the coordinates of the input point in the virtual space based on the structure information and displays only the identified structure on the display screen in a predetermined highlighting mode.

6. The three-dimensional data display apparatus according to claim 5, further comprising a physical property information display processing section that identifies a structure located at the coordinates of the input point in the virtual space based on the structure information, creates a physical property value information screen that displays physical property value information of the identified structure and displays the physical property value information screen on the display device.

7. The three-dimensional data display apparatus according to claim 1, wherein the input point position calculation section generates a grid table that stores coordinates of the each grid lattice, coordinates of vertexes of the structure and coordinates of a point of intersection between the boundary of the structure and the grid and selects the coordinates of the moving destination of the input point from the grid table.

8. The three-dimensional data display apparatus according to claim 1, wherein the input point position calculation section calculates moving tracks of the input point based on the moving direction of the operation information and selects any one of the coordinates of the grid lattice in the calculated moving direction and the coordinates of a point of intersection between the moving tracks and the structure as the coordinates of the moving destination.

9. The three-dimensional data display apparatus according to claim 1, further comprising a sketch plane setting section that sets an arbitrary plane in the virtual space as a sketch plane,
wherein the screen display processing section displays the sketch plane set in the virtual space on the display screen.

10. The three-dimensional data display apparatus according to claim 9, wherein the input point position calculation section associates, when the pointing input device comprises a wheel and operation by plane movement or wheel rotation is possible, the moving direction of the operation information generated by the plane movement with a coordinate axis that identifies the sketch plane and further associates the moving direction of the operation information generated by the wheel rotation with the coordinate axis in a direction perpendicular to the sketch plane, stores association information indicating the association and calculates the moving destination of the input point from the acquired operation information based on the association information.

11. The three-dimensional data display apparatus according to claim 9, wherein the sketch plane setting section identifies a boundary plane of the structure on which the coordinates of the input point in the virtual space are located and sets the identified boundary plane as the sketch plane.

12. The three-dimensional data display apparatus according to claim 9, wherein the screen display processing section calculates a line of intersection between a boundary plane of the structure arranged in the virtual space and the sketch plane based on the structure information and displays the calculated line of intersection on the display screen.

13. The three-dimensional data display apparatus according to claim 1, wherein the screen display processing section acquires a rotation coordinate axis selected from the orthogonal coordinate axis in the virtual space and an angle of rotation inputted through operation of the pointing input device and displays a virtual space of the rotation coordinate system converted by rotating the orthogonal coordinate axis in the virtual space based on the rotation coordinate axis and the angle of rotation on the display screen.

14. The three-dimensional data display apparatus according to claim 1, further comprising a display mode setting section that sets, when the input point is moved, any one display mode of a space fixing mode in which the input point of the display screen is moved and displayed and an input point fixing mode in which the virtual space is moved and displayed,
wherein the screen display processing section generates the display screen based on the set display mode.

15. The three-dimensional data display apparatus according to claim 1, wherein the screen display processing section identifies a straight line parallel to each coordinate axis in the virtual space, which is a line segment from the coordinates of the input point to a point of intersection with the boundary plane of the nearest structure and displays the identified line segment as a guideline.

16. The three-dimensional data display apparatus according to claim 1, further comprising a grid spacing setting section that sets the grid spacing.

17. The three-dimensional data display apparatus according to claim 1, further comprising a structure information creating section that generates, when an operation of adding a structure in the virtual space is performed through the operation of the pointing input device, structure information of the structure based on the information inputted at the position of the input point and stores the structure information in the structure information storage section.

18. A three-dimensional data display method executed by a computer provided with a display device and a pointing input device for displaying a structure to be processed in a virtual space on the display device, comprising:
generating, based on structure information obtained from a structure information storage section that stores the structure information including structure information indicating the shape and arrangement of the structure and physical property value information indicating a material and predetermined physical property values, a display screen with the structure arranged in a virtual space of a three-dimensional orthogonal coordinate system;
displaying the generated display screen on the display device;
setting a grid in the virtual space based on predetermined grid spacing;
acquiring operation information indicating a moving direction and an amount of movement of the input point from the pointing input device;
calculating coordinates of the input point in the virtual space and calculating a moving destination of the input point based on the operation information;
selecting any one of coordinates of each grid lattice based on the set grid, coordinates of a boundary of the structure and coordinates of a point of intersection between the boundary of the structure and the grid as the coordinates of the moving destination and updating the coordinates of the input point with the selected coordinates; and
displaying, when the coordinates of the input point are updated, the input point at a position indicating the coordinates at which the input point in the virtual space is updated.
